(19) United States
(12) Patent Application Publication
(10) Pub. No.: US 2025/0091750 A1
(43) Pub. Date: Mar. 20, 2025

(54) DEFECT RATE REDUCTION METHOD FOR FINISHED PRODUCTS BASED ON TRADEMARK SURFACE PARAMETER DETECTION AND CONTROL

(71) Applicant: HONGYUN HONGHE TOBACCO (GROUP) CO., LTD., Kunming (CN)

(72) Inventors: Jun Jiao, Kunming (CN); Hong Liang, Kunming (CN); Bingtong Liu, Kunming (CN); Mingbing Yao, Kunming (CN); Yu Zhao, Kunming (CN); Jiandong Zhu, Kunming (CN); Jing He, Kunming (CN); Duoqing Fan, Kunming (CN); Jinglie Hao, Kunming (CN)

(21) Appl. No.: 18/963,570

(22) Filed: Nov. 28, 2024

Related U.S. Application Data
(63) Continuation of application No. PCT/CN2024/070624, filed on Jan. 4, 2024.

(30) Foreign Application Priority Data
Mar. 9, 2023 (CN) 202310223221.4

(51) Int. Cl. B65B 57/02; G06T 7/00; G06T 7/13; G06T 7/60; G06T 7/80

(52) U.S. Cl. CPC B65B 57/02; G06T 7/0006; G06T 7/13; G06T 7/60; G06T 7/80; G06T 2207/20024

(57) ABSTRACT

A defect rate reduction method for finished products is disclosed. First, size parameters of various types of trademarks, indentations, and printed patterns are entered into a database to generate basic images, a corresponding standard trademark image is collected in real time for each basic image, and edge finding parameter optimization is manually performed, to find edge finding parameters that can be used to accurately extract the trademark edge, the indentation edge, and printed pattern edge on the standard trademark image, to complete the database modeling; sampling detection is performed, edge information is extracted based on a database model, a corresponding distance is calculated based on each extracted edge data information, and the information is compared with internal control to determine surface parameter quality of the sample trademark respectively, it is determined whether production requirements are met based on a determination result, and the unqualified batch of trademarks is eliminated.

### CROSS REFERENCE TO RELATED APPLICATIONS

The present application is a Continuation application of PCT Application No. PCT/CN2024/070624 filed on Jan. 4, 2024, which claims the benefit of Chinese Patent Application No. 202310223221.4 filed on Mar. 9, 2023. All the above are hereby incorporated by reference in their entirety.

### TECHNICAL FIELD

The present invention relates to a tobacco trademark quality detection and control method, and in particular, to a defect rate reduction method for finished products based on trademark surface parameter detection and control.

### BACKGROUND

The appearance quality of cigarettes is a top priority indicator in cigarette production, and includes the appearance quality of cigarettes, the appearance quality of packs, and the appearance quality of cartons. Packs and cartons are collectively called trademarks in the cigarette industry. The appearance quality of trademarks depends on factors of trademark print quality, trademark die-cut sizes, and trademark die-cut indentation quality.

Trademark print quality defects cause the appearance quality problem of misalignment of upper and lower lid patterns of a finished product. FIG. 6 and FIG. 7 are schematic diagrams of comparison between pack trademarks and carton trademarks that have appearance quality problems due to trademark print quality defects and qualified products.

Unqualified trademark die-cut size indicators cause loose packaging, uneven packaging, or even detachment. More seriously, the packaging machine cannot package the trademark. The trademark die-cut size quality defect causes pack trademarks to be unable to adapt to the packaging machine and consequently causes quality problems of the exposed lid of the cigarette pack and the exposed beveled corners. The trademark die-cut size quality defect causes carton trademarks to be unable to adapt to the packaging machine and consequently causes quality problem of edge folding of carton packaging. FIG. 2 and FIG. 3 are schematic diagrams of comparison between pack trademarks and carton trademarks that have appearance quality problems due to trademark die-cut size defects and qualified products.

The quality of trademark die-cut indentation includes the quality of indentation width and indentation depth. During the production process of folding to form the trademark, it is necessary to make an indentation before folding. The indentation can act as a guide for folding, which is helpful for the final folding to form the trademark, so that the folded packaging pack is smoother and more beautiful. Generally, the control tolerance of the trademark indentation width is within 0.3 mm. If the trademark indentation width is excessively wide or narrow, it may cause the trademark to be less three-dimensional after folding, and the folding angle is not 90°. As a result, the final package cannot fit tightly and causes quality problems. Unqualified indentation depth quality results in the production of defective products with cracked edges. Because there are too many trademark folded edges, the accumulation of errors in all the folded edges may even directly cause the final failure to fold smoothly or getting stuck in the packaging machine. FIG. 4 and FIG. 5 are schematic diagrams of comparison between pack trademarks and carton trademarks that have appearance quality problems due to trademark die-cut indentation width defects and qualified products. FIG. 8 and FIG. 9 are schematic diagrams of comparison between pack trademarks and carton trademarks that have appearance quality problems due to trademark die-cut indentation depth defects and qualified products.

At present, quality detection almost always takes the formed cigarette packs as detection objects. However, since trademark surface parameter detection is not considered before production, to control the quality of the trademark raw materials, when defective products are found in the current production stage, a batch of finished products have been produced. Therefore, not only a series of defective product removal processes need to be completed, but also the machine needs to be stopped to check the reasons. While causing material waste, it also greatly reduces production efficiency and affects the entire industry chain. More seriously, it has caused packaging equipment to get stuck and shut down. Therefore, trademark surface parameter detection and control of raw materials need to be considered before production to reduce the defect rate of finished products. It is of practical significance for cigarette producers and trademark printers to control quality defects and improve product quality.

Furthermore, when using the existing technology to detect trademark surface parameters such as the trademark indentation width, parameters are usually measured manually with rulers and calipers. Manual measurement has large errors (greater than 0.5 mm), low efficiency, and cannot implement full sampling and detection, making it difficult to meet the detection and quality control requirements of the trademark indentation width. The measurement of trademark die-cut sizes is mostly done manually with measuring tools such as rulers and calipers. Since there are many items to be detected and the continuous process is long, manual measurement has the following problems:
1) It is time-consuming and labor-intensive, has low efficiency, has limited detection samples, and has lags in data, which is not conducive to the control of trademark surface parameter quality.
2) The detection precision is not high and the highest detection precision is only 0.1 mm, which cannot meet the precise measurement of trademark surface parameters.
3) The precision is not high. Due to differences in the subjective measurement habits of individual detection personnel, the reproducibility of the detection results is poor and the reliability of the detection results is low.

The present invention is based on an apparatus for detecting a trademark die-cut size, an angle, and an indentation width disclosed in Chinese utility model patent CN202121323819.3, and detects trademarks and trademark printed patterns, trademark indentation depths, trademark indentation widths, and trademark die-cut sizes. When measuring the trademark indentation depth, a laser detection head is installed at the position of the CCD line scan camera in the original application. The present invention reduces the defect rate of finished products based on trademark surface parameter detection and control.

### SUMMARY

The present invention provides a defect rate reduction method for finished products based on trademark surface parameter detection and control, including detection and control of a trademark printed pattern position of the trademark raw material, a trademark die-cut size, and a trademark die-cut indentation width and depth, so as to perform quality control on trademark raw materials, eliminate unqualified raw materials, and eliminate defective products from the source. Specifically, the method of the present invention is as follows:

A defect rate reduction method for finished products based on trademark surface parameter detection and control, including the following steps:
S1: performing pixel calibration: measuring a size of each pattern on a calibration piece with a CCD camera to obtain a corresponding pixel pattern, and establishing a correspondence between a display pixel and an actual size based on a ratio of the actual size to a size of the corresponding pixel pattern;
S2: performing database modeling: entering size parameters of various types of trademarks, printed patterns on the trademarks, and indentations on the trademarks into a database to generate basic images, collecting a corresponding standard trademark image in real time with the CCD camera for each basic image, and manually performing edge finding parameter optimization on the standard trademark image, to respectively find edge finding parameters that can be used to accurately extract the trademark edge, the indentation edge on the trademark, and printed pattern edge on the trademark on the standard trademark image, to complete the database modeling;
S3: extracting information: conducting sampling detection on a to-be-detected batch of trademarks, placing the to-be-detected sample trademark in an image collection area, setting a moving path of an edge finding frame of the CCD camera based on a database model, and collecting a to-be-detected trademark image with the CCD camera, to respectively extract a trademark edge, an indentation edge on the trademark, and a printed pattern edge on the trademark;
S4: performing quality determination: calculating a corresponding distance based on each extracted edge data information, and comparing the information with internal control to determine surface parameter quality of the sample trademark respectively, where the surface parameter quality includes the trademark die-cut size quality, trademark indentation width quality, and trademark print quality; and
S5: eliminating an unqualified batch: determining whether the batch of trademarks of the sample meets production requirements based on a determination result of the surface parameter quality of the sample, and if any surface parameter quality fails, determining that the batch of trademarks of the sample is unqualified, and eliminating the unqualified batch of trademarks from raw material.

Further, the edge finding parameter in step S2 includes precision, boundary strength, threshold, and burr size, and a worker optimizes the edge finding parameters in sequence.

Further, the optimization of the edge finding parameter in step S2 includes the following steps:
S2.1: performing precision selection, and performing Gaussian smoothing filtering on the collected CCD trademark image based on a 3×3 Gaussian filter window size, to eliminate noise interference;

$$G ( x , y ) = \frac{1}{2 π {σ}^{2}} {e}^{- ( {x}^{2} + {y}^{2} ) / ( 2 {σ}^{2} )} ; \qquad ( 1 )$$

where in formula (1), σ is a standard deviation of Gaussian distribution, G (x, y) represents a filtered image, x and y are coordinate positions of pixels; σ² is defined as image filtering precision, under the condition that a template is fixed, image noise suppression and image smoothing of different trademarks and print patterns are implemented by adjusting a σ² value, and the σ² value ranges from 1 to 20;
S2.2: performing grayscale conversion on the Gaussian filtered image to obtain a grayscale image of the trademark, where in conversion from RGB to YUV color spaces, a specific calculation method is:

$$Y = 0. 299 R + 0.587 G + 0.1 \; 14 B ; \qquad ( 2 )$$

$$U = 0. 4 \; 93 ( B - Y ) ; and \qquad ( 3 )$$

$$V = 0. 8 \; 77 ( R - Y ) ; \qquad ( 4 )$$

where in formulas (2), (3), and (4), R is the red component, G is the green component, B is the blue component, Y is brightness, U is chrominance, and V is chroma;
S2.3: performing edge detection on the grayscale image by using a Sobel operator, and extracting point coordinates of the trademark edge, the indentation edge on the trademark, and the printed pattern edge on the trademark; and
S2.4: performing fitting according to a least squares method based on coordinate points (x₁, y₁), (x₂, y₂), . . . , and (xₘ, yₘ) of the trademark edge, the indentation edge on the trademark, and the printed pattern edge on the trademark extracted by using the Sobel operator, where a regression equation of the least squares method is:

$$\hat{y} = \hat{a} + \hat{b} x ; \qquad ( 8 )$$

where the least squares method is used to minimize the sum of squares of deviations of yᵢ and a+bxᵢ, to obtain:

$$\hat{b} = \frac{{\sum }_{i = 1}^{m} ( {x}_{i} - \overline{x} ) ( {y}_{i} - \overline{y} )}{{\sum }_{i = 1}^{m} {( {x}_{i} - \overline{x} )}^{2}} , \hat{a} = \overline{y} - \hat{b} \overline{x} ; \qquad ( 9 )$$

$$\overline{y} = \frac{1}{m} ( {y}_{1} + {y}_{2} + … + {y}_{m} ) \\ \overline{x} = \frac{1}{m} ( {x}_{1} + {x}_{2} + … + {x}_{m} ) \qquad ( 10 )$$

where:

Through the above steps, a straight line of each trademark edge, each indentation edge on the trademark, and each printed pattern edge on the trademark can be fitted, after first linear regression analysis, a pixel distance from each point to the fitted straight line is calculated, that is, the burr size, the burr size ranges from 1 pixel to 50 pixels, and the burr size is set to remove discrete points with large distances.

Further, the step S2.3 includes following steps:
S2.3.1: the Sobel operator includes two 3×3 matrices that are horizontal and vertical respectively, performing plane convolution on the matrices and the grayscale image, to respectively obtain approximate values of horizontal and vertical grayscale gradients:

$${G}_{x} = [ \begin{matrix}- 1 & 0 & + 1 \\ - 2 & 0 & + 2 \\ - 1 & 0 & + 1\end{matrix} ] * A ; and \qquad ( 5 )$$

$${G}_{y} = [ \begin{matrix}- 1 & - 2 & - 1 \\ 0 & 0 & 0 \\ + 1 & + 2 & + 1\end{matrix} ] * A ; \qquad ( 6 )$$

where in formulas (5) and (6), Gₓ and G_{y} represent the approximate values of the horizontal and vertical gradients respectively, and A represents the original grayscale image;
S2.3.2: calculating a grayscale gradient based on horizontal and vertical grayscale gradients of each pixel in the image:

$$G = \sqrt{{G}_{x}^{2} + {G}_{y}^{2}} ; and \qquad ( 7 )$$

S2.3.3: selecting an appropriate boundary strength B and gradient threshold T, and comparing a grayscale value and a grayscale gradient of each pixel in the edge finding frame area with B and T respectively based on a row-by-row or column-by-column search method, where only points that satisfy both grayscale value A (x, y)≥B and gradient G (x, y)≥T are edge points, and other points are non-edge points.

Further, the threshold T ranges from 0.1 to 0.95; the boundary strength B for extracting the trademark edge ranges from 1 to 200; the boundary strength B for extracting the indentation edge on the trademark ranges from 32 to 59; and the boundary strength B for extracting the printed pattern edge on the trademark ranges from 1 to 76.

Further, in steps S2 and S3, a combined LED light source is used when collecting images with the CCD camera, the combined LED light source includes a top light source arranged around the CCD camera and a bottom light source arranged below the image collection area; the top light source includes a top upper light source, a top lower light source, a top left light source, and a top right light source; the top light source is used to extract the printed pattern edge on the trademark and a light source intensity coefficient of the top light source is between 31 and 77; the top light source is used to extract the indentation edge and a light source intensity coefficient of the top light source is between 31 and 49; the bottom light source is used to extract the trademark edge and a light source intensity coefficient of the bottom light source is between 25 and 60; when measuring an upper edge of a transverse indentation, only the top upper light source is turned on; when measuring a lower edge of the transverse indentation, only the top lower light source is turned on; when measuring a left edge of a longitudinal indentation, only the top left light source is turned on; and when measuring a right edge of the longitudinal indentation, only the top right light source is turned on.

Further, the trademark includes a pack trademark and a carton trademark, a determination method of trademark print quality of the pack trademark in step S4 is: transversely placing the pack trademark, dividing the printed pattern on the pack trademark into three areas of left, middle, and right areas according to pattern edges, grayscale differences, and positions after folding into the box, respectively calculating distances from the printed pattern in each area to upper and lower side edges of the pack trademark, determining print quality defect based on the calculated distances; where the print quality defect determination includes a deviation degree and a skewness degree; calculating absolute values of differences between distances from upper and lower side edges of the printed pattern in each area to the upper and lower side edges of the pack trademark to determine deviation degrees of the printed patterns in the three areas; and calculating an absolute value of a difference between a distance from the printed pattern edge in the left area on the same side to the edge of the pack trademark and a distance from the printed pattern edge in the right area to the edge of the pack trademark to determine the overall skewness degree of the printed pattern; and a determining method of trademark print quality of the carton trademark in step S4 is: transversely placing the top of the carton trademark to the left, dividing into two areas of an upper detection area and a lower detection area according to pattern edges, grayscale differences, and positions after folding into the box, and calculating absolute values of differences between distances from the printed pattern edges in the two areas to the edge of the carton trademark on the same side to determine the overall skewness degree of the printed pattern.

Further, the trademark includes a pack trademark and a carton trademark; in determining of the trademark indentation width quality in step S4, all indentations are divided into a critical indentation group and a non-critical indentation group, indentations at gluing and folding positions and indentations at critical folding positions for cigarette pack forming belong to the critical indentation group, the remaining indentations belong to the non-critical indentation group, if the critical indentation group includes one indentation with a width exceeding an internal control range, it is determined that the trademark indentation width quality fails, and if the non-critical indentation group includes more than two indentations with widths exceeding the internal control range, it is determined that the trademark indentation width quality fails.

Further, the trademark includes a pack trademark and a carton trademark; in determining of the trademark die-cut size quality in step S4, sizes of various parts that affect the effect of trademark pack forming are first marked as different detection sequences, all the detection sequences are divided into a critical detection sequence group and a non-critical detection sequence group, detection sequences at gluing and folding positions belong to the critical detection sequence group, the remaining detection sequences belong to the non-critical detection sequence group, if the critical detection sequence group includes one detection sequence with a size exceeding an internal control range, it is determined that the trademark die-cut size quality fails, and if the non-critical detection sequence group includes more than two detection sequences with sizes exceeding the internal control range, it is determined that the trademark die-cut size quality fails.

Further, between step S4 and step S5, determining of trademark indentation depth quality is further included; the trademark includes a pack trademark and a carton trademark; and the determining of the trademark indentation depth quality includes the following steps:
S4.1: selecting points for distance measurement: replacing the CCD camera on detection equipment with a laser detection head, measuring to-be-measured indentation depths of samples one by one through laser ranging, where a laser path is perpendicular to the trademark surface during measurement, and performing laser ranging on several points between two side edges of each to-be-measured indentation along a specific distance, to measure a distance between each point and the laser head;
S4.2: performing indentation depth calculation: subtracting a minimum value of measured distances from a maximum value to obtain an indentation depth; and
S4.3: performing indentation depth quality determination: grouping all indentations according to a process of folding the trademark into a box and a position of each indentation in the trademark, where different quality determination standards are used for different groups of indentations, comparing all indentations with an indentation internal control range, and determining, according to different quality determination standards, whether the indentation depth quality is fine.

Further, when selecting points for distance measurement in step S4.1, points start to be selected from a trademark surface that is on one side of the indentation and that is 5 mm away from the indentation, a line connecting the selected measurement points passes through the inside of the indentation, points are selected for distance measurement until a position that is on the other side of the indentation and that is 5 mm away from the edge of the other side of the indentation, thirty points evenly spaced between the start point and the end point are collected, a line connecting the selected measurement points passes through the midpoint of each indentation, a line connecting points selected when measuring each indentation is perpendicular to the indentation, each indentation is measured in sequence from left to right and from top to bottom during distance measurement, after each indentation is measured, the laser head moves in a straight line from a collection end point of the measured indentation to a collection start point of a next to-be-measured indentation, and when measuring a distance of a first indentation, a moving path of the laser head points to a second indentation.

Further, in step S4.3, all indentations are divided into a critical indentation group and a non-critical indentation group, indentations at gluing and folding positions and indentations at critical folding positions for cigarette pack forming belong to the critical indentation group, the remaining indentations belong to the non-critical indentation group, if the critical indentation group includes one indentation with a depth exceeding an internal control range, it is determined that the trademark indentation width quality fails, and if the non-critical indentation group includes more than two indentations with depths exceeding the internal control range, it is determined that the trademark indentation width quality fails.

The working principle of the present invention is as follows:

In this method, basic images are first generated in the system based on the size data of various types of trademarks; then edge finding parameters such as the edge-finding frame precision, boundary strength, threshold, and burr size are manually optimized, the best condition of extracting the standard trademark edge, the trademark indentation edge, and the printed pattern edge on the trademark by the CCD camera is provided, a model is established after matching with the basic images and the model is stored in the database; then the trademark edge, trademark indentation edge, and the printed pattern edge on the trademark are extracted under irradiation of a combined LED light source, and the required distances are respectively calculated, and then the distances are compared with the internal control to determine the surface parameter quality of the sample trademark respectively. The surface parameter quality includes the trademark die-cut size quality, the trademark indentation width quality, and the trademark print quality. The pass rate of each surface parameter of the sample trademark is further used to determine whether the batch of the sample is qualified, and unqualified batch of trademarks is eliminated from the raw materials.

When selecting precision, the standard deviation has a great impact on the smoothing ability of a Gaussian filter. As a is larger, the frequency band of the Gaussian filter is wider and the smoothness of an image is better. However, the measured trademark is close to a plane rather than three-dimension. Besides, due to the color and printing ink of the printed pattern or the like, excessive smoothness of the image causes it to be unrecognizable. When the value is set to 1 to 20, the extraction effect is best. Due to the differences in colors, backgrounds, and textures of various types of trademarks, the range is also determined based on an actual case when optimizing the edge finding parameters. In combination with the use of the combined LED light source, the extraction effect of the trademark edge, the trademark indentation edge, and the printed pattern edge is further enhanced. When modeling, the extraction parameters of various types of trademark edges, trademark indentation edges, and printed pattern edges are adjusted to the best state.

The measurement error of straight line primitives mainly comes from the positioning error of edge objects. In this method, the least squares method is used to fit the straight line primitives, and the impact of isolated noise points on the edge is eliminated by calculating distances, avoiding complex algorithm operations.

When measuring the indentation depth, a position that is outside two side edges of each indentation and that is 5 mm away from the edges is used as the start point in laser ranging, laser ranging is performed on thirty points evenly spaced, the distance between each point and the laser head is measured, and the line connecting the measured points is perpendicular to the indentation and passes through the midpoint of the indentation, ensuring the shortest measurement path and the most even spacing between measurement points and improving detection precision. Among the thirty pieces of measured data, the maximum value minus the minimum value is the indentation depth. During measurement, the moving path of the laser head vertically passes through the midpoint of each indentation. After each indentation is measured, the laser head moves in a straight line from a collection end point of the measured indentation to a collection start point of a next to-be-measured indentation, and when measuring a distance of a detected first indentation, a moving path of the laser head points to a detected second indentation, which can minimize the moving path of the laser head during ranging, save the measurement time, and improve overall measurement efficiency.

Besides, when determining the trademark indentation quality and the trademark die-cut size quality, indentations are divided into a critical indentation group and a non-critical indentation group according to positions of the indentations, functions of the indentations, and positions of die-cut size detection sequences for separate determination. The two groups use different quality determination standards to improve the precision of determining qualified trademarks and unqualified trademarks and avoid unnecessary elimination and waste.

The beneficial effects of the present invention are as follows:
(1) The quality of the trademark is controlled by detecting the surface parameters of the trademark at the front end of production, the suitability of placing the trademark on the machine is determined to determine whether the trademark meets the production standard, and raw materials that produce defective products are eliminated from the source. There is no need to start shutdown check to eliminate defective products only when a problem occurs in the quality detection step of finished products or the production process. This avoids waste of production materials and greatly improves production efficiency. After using this method, the overall defect rate in the production factory drops by about 51.72% in a single day; and the defect rate caused by unqualified trademarks decreases by about 32.32%, which effectively reduces the defect rate of finished products, saves a series of supporting materials, and improves production efficiency.
(2) This detection method is aimed at the complex patterns and backgrounds of trademarks. Based on the optimization of edge finding parameters such as the measurement precision, the threshold, the burr size, and the boundary strength, a set of detection methods is constructed. In combination with the use of the combined LED light, the method avoids complex algorithm processing, has a low usage condition and a wide application range, and implements rapid and accurate detection of defects in trademark surface parameter quality.
(3) This method has the characteristics of high detection precision, a fast speed, and a simple operation, and can meet the detection demand of defect of trademark surface parameter quality and improve detection efficiency. In manual detection, not many samples can be extracted for detection due to excessively low efficiency. After using this method, the number of samples that can be detected for each batch of trademarks is increased, further improving the detection precision, optimizing the detection results, and avoiding incorrect detection and mistaken elimination. Therefore, the method has good application promotion values.

### BRIEF DESCRIPTION OF THE DRAWINGS

FIG. 1 is a schematic flowchart of Embodiment 1 of the present invention;

FIG. 2 is a schematic diagram of comparison between qualified trademark finished products and defective finished products caused by trademark die-cut size defects according to the present invention;

FIG. 3 is a schematic diagram of comparison between qualified trademark finished products and defective finished products caused by trademark die-cut size defects according to the present invention;

FIG. 4 is a schematic diagram of comparison between qualified trademark finished products and defective finished products caused by trademark indentation width defects according to the present invention;

FIG. 5 is a schematic diagram of comparison between qualified trademark finished products and defective finished products caused by trademark indentation width defects according to the present invention;

FIG. 6 is a schematic diagram of comparison between qualified trademark finished products and defective finished products caused by trademark print defects according to the present invention;

FIG. 7 is a schematic diagram of comparison between qualified trademark finished products and defective finished products caused by trademark print defects according to the present invention;

FIG. 8 is a schematic diagram of comparison between qualified trademark finished products and defective finished products caused by trademark indentation depth defects according to the present invention;

FIG. 9 is a schematic diagram of comparison between qualified trademark finished products and defective finished products caused by trademark indentation depth defects according to the present invention;

FIG. 10 is a diagram of comparison between successful edge finding examples and failed edge finding examples of a pack trademark and a printed pattern of a pack trademark according to Embodiment 1 of the present invention;

FIG. 11 is a diagram of comparison between successful edge finding examples and failed edge finding examples of an indentation of a pack trademark according to Embodiment 1 of the present invention;

FIG. 12 is a diagram of comparison between successful edge finding examples and failed edge finding examples of a pack trademark and a printed pattern of a pack trademark according to Embodiment 1 of the present invention;

FIG. 13 is a diagram of comparison between successful edge finding examples and failed edge finding examples of an indentation of a pack trademark according to Embodiment 2 of the present invention;

FIG. 14 is a schematic diagram of a basic image of a to-be-detected pack trademark and area division according to Embodiment 1 of the present invention;

FIG. 15 is a schematic diagram of a basic image of a to-be-detected carton trademark and area division according to Embodiment 1 of the present invention;

FIG. 16 is a schematic diagram of a basic image of a to-be-detected pack trademark and a to-be-detected indentation according to Embodiment 2 of the present invention;

FIG. 17 is a schematic diagram of a basic image of a to-be-detected carton trademark and a to-be-detected indentation according to Embodiment 2 of the present invention;

FIG. 18 is a schematic diagram of a basic image of a to-be-detected pack trademark and a detection sequence according to Embodiment 3 of the present invention;

FIG. 19 is a schematic diagram of a basic image of a to-be-detected carton trademark and a detection sequence according to Embodiment 3 of the present invention;

FIG. 20 is a schematic diagram of a pack trademark located in the coordinate system according to Embodiment 4 of the present invention;

FIG. 21 is a schematic diagram of a moving path of a laser head when detecting the pack trademark according to Embodiment 4 of the present invention;

FIG. 22 is a schematic diagram of a carton trademark located in the coordinate system according to Embodiment 4 of the present invention;

FIG. 23 is a schematic diagram of a moving path of a laser head when detecting the carton trademark according to Embodiment 4 of the present invention; and

FIG. 24 is a schematic diagram of a calibration component according to Embodiment 1 of the present invention.

### DETAILED DESCRIPTION

In order to make it easy to understand the technical means, creative features and objectives achieved by the present invention, the technical solutions of the present invention will be further described below in conjunction with the embodiments and specific implementations of the defect rate reduction method for finished products based on trademark surface parameter detection and control given in the present invention.

Specific embodiments given for the present invention are as follows:

The present invention is based on an apparatus for detecting a trademark die-cut size, an angle, and an indentation width disclosed in Chinese utility model patent CN202121323819.3, and detects trademarks and trademark printed patterns.

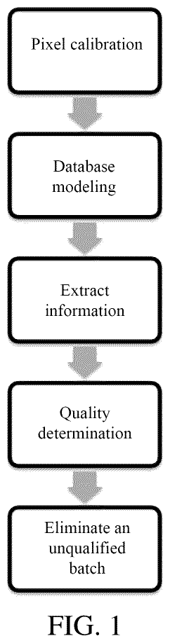

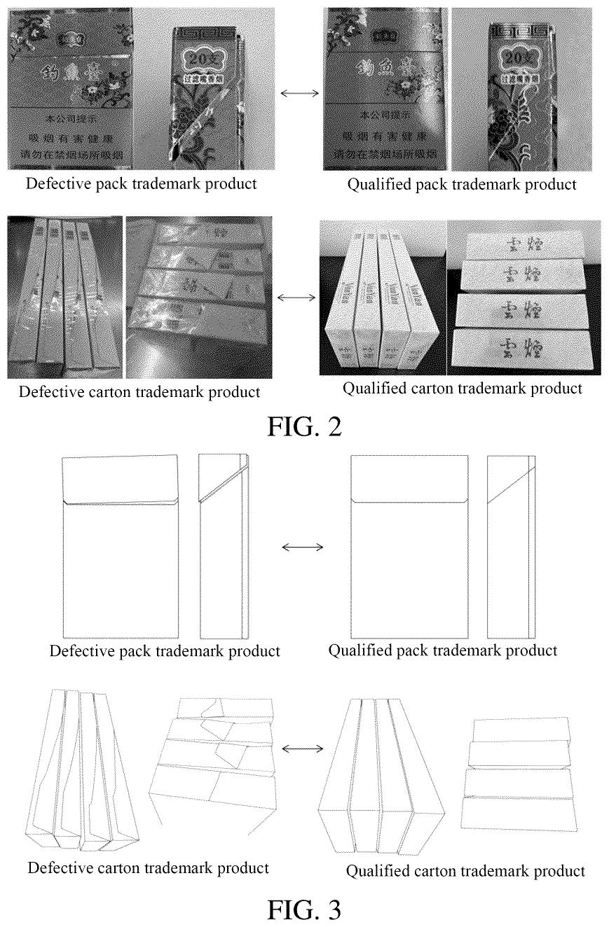

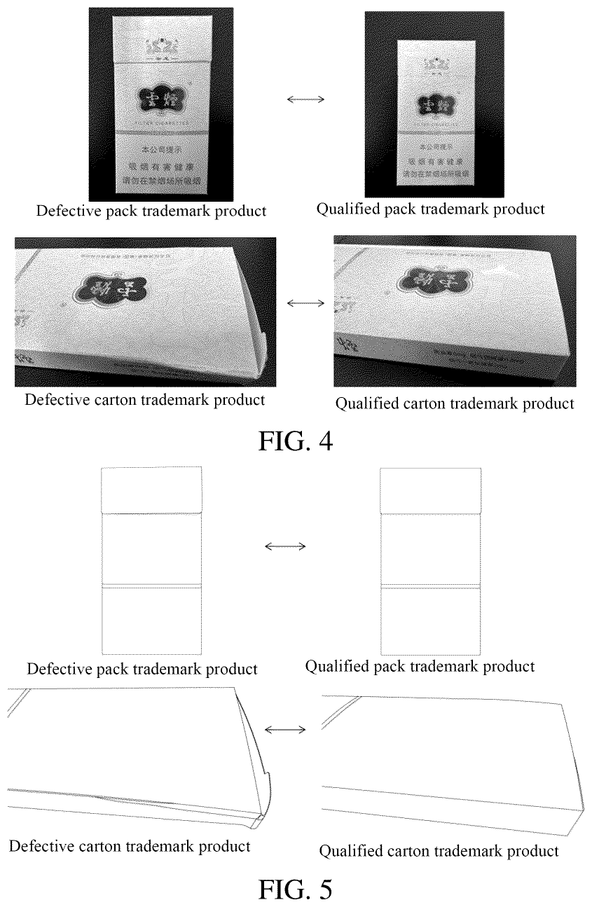

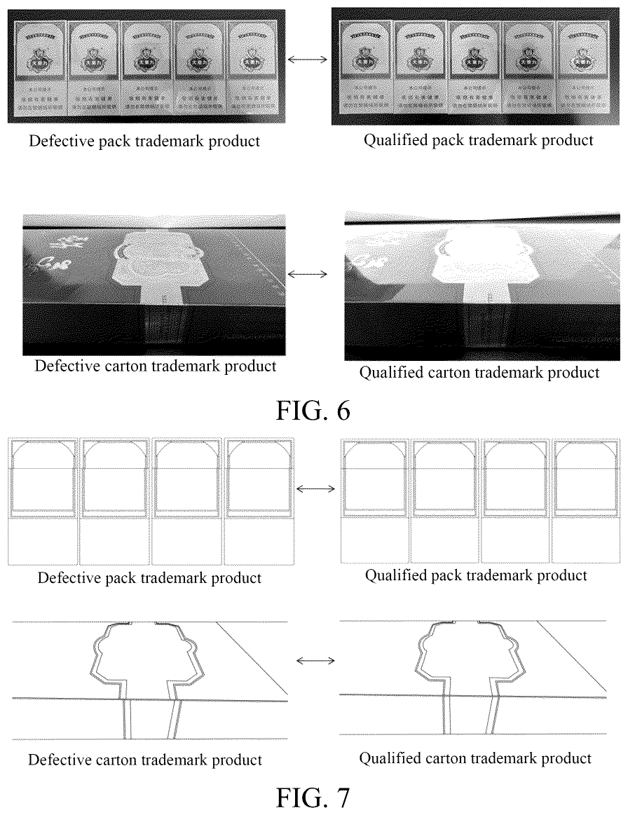

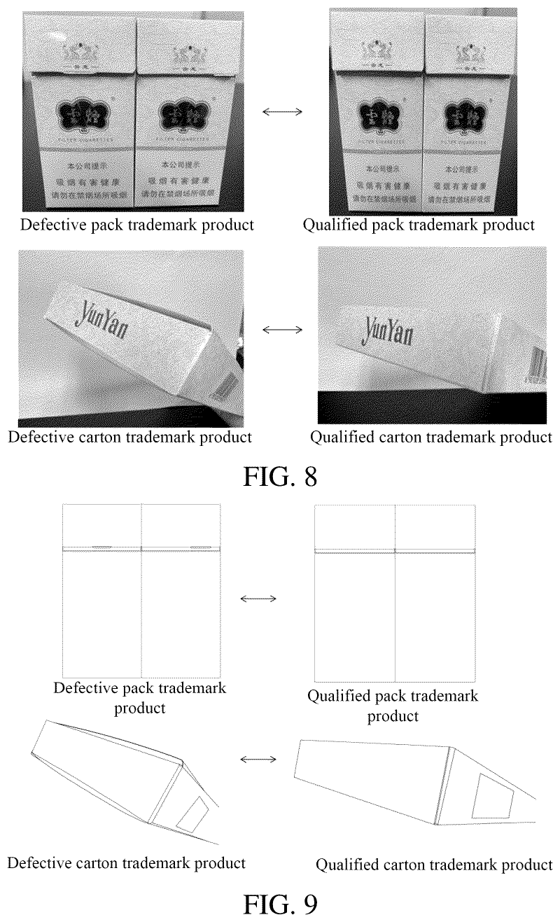

### Embodiment 1: Determination of Trademark Print Quality, as Shown in FIG. 1

S1: Perform pixel calibration: measure a size of each pattern on a calibration piece with a CCD camera to obtain a corresponding pixel pattern, where the calibration piece is shown in FIG. 24, and establish a correspondence between a display pixel and an actual size based on a ratio of the actual size to a size of the corresponding pixel pattern.

S2: Perform database modeling: enter size parameters of various types of trademarks, printed patterns on the trademarks, and indentations on the trademarks into a database to generate basic images, and collect a corresponding standard trademark image in real time with the CCD camera for each basic image. FIG. 16 shows a basic image of to-be-detected trademark indentations, where indentation numbers 1 to 18 are the to-be-detected indentations. FIG. 18 is a basic image of a standard trademark of one specification and a to-be-detected sequence standard thereof. Then, edge finding parameter optimization is manually performed on the standard trademark image. Edge finding refers to accurately finding and extracting the trademark edge, the indentation edge on the trademark, and the printed pattern edge on the trademark. Edge finding parameters that can be used to accurately extract the trademark edge, the indentation edge on the trademark, and printed pattern edge on the trademark on the standard trademark image are found, to complete the database modeling. The optimized edge finding parameters sequentially include the edge finding frame precision, the boundary strength, the threshold, and the burr size. Optimization steps include:

S2.1: Perform precision selection, and perform Gaussian smoothing filtering on the collected CCD trademark image based on a 3×3 Gaussian filter window size, to eliminate noise interference:

$$G ( x , y ) = \frac{1}{2 π {σ}^{2}} {e}^{- ( {x}^{2} + {y}^{2} ) / ( 2 {σ}^{2} )} ; \qquad ( 1 )$$

In formula (1), σ is a standard deviation of Gaussian distribution, G(x, y) represents a filtered image, and x and y are coordinate positions of pixels. The standard deviation has a great impact on the smoothing ability of a Gaussian filter. As σ is larger, the frequency band of the Gaussian filter is wider and the smoothness of an image is better. However, the trademark is close to a plane. Besides, due to the impact by the color, pattern, and printing ink of the printed pattern or the like, excessively large σ causes extraction failure. In algorithm programming, σ² is defined as the precision of image filtering. Different σ² values need to be set according to different types of trademarks to achieve suppression and image smoothing of different trademarks and printed image noise. Herein, the extraction effect is the best when σ² is set to 1 to 20.

S2.2: Perform grayscale conversion on each Gaussian filtered image to obtain a grayscale image of the trademark, where in conversion from RGB to YUV color spaces, a specific calculation method is:

$$Y = 0. 299 R + 0.587 G + 0.1 \; 14 B ; \qquad ( 2 )$$

$$U = 0.493 ( B - Y ) ; and \qquad ( 3 )$$

$$V = 0.877 ( R - Y ) ; \qquad ( 4 )$$

where in formulas (2), (3), and (4), R is the red component, G is the green component, B is the blue component, Y is brightness, U is chrominance, and V is chroma.

S2.3: Perform edge detection on the grayscale image by using a Sobel operator, and extract point coordinates of the trademark edge, the indentation edge on the trademark, and the printed pattern edge on the trademark.

S2.3.1: The Sobel operator includes two 3×3 matrices that are horizontal and vertical respectively, and perform plane convolution on the matrices and the grayscale image, to respectively obtain approximate values of horizontal and vertical grayscale gradients:

$${G}_{x} = [ \begin{matrix}- 1 & 0 & + 1 \\ - 2 & 0 & + 2 \\ - 1 & 0 & + 1\end{matrix} ] * A ; and \qquad ( 5 )$$

$${G}_{y} = [ \begin{matrix}- 1 & - 2 & - 1 \\ 0 & 0 & 0 \\ + 1 & + 2 & + 1\end{matrix} ] * A ; \qquad ( 6 )$$

where in formulas (5) and (6), Gₓ and G_{y} represent the approximate values of the horizontal and vertical gradients respectively, and A represents the original grayscale image.

S2.3.2: Calculate a grayscale gradient based on horizontal and vertical grayscale gradients of each pixel in the image:

$$G = \sqrt{{G}_{x}^{2} + {G}_{y}^{2}} ; \qquad ( 7 )$$

S2.3.3: Select an appropriate boundary strength B and gradient threshold T, and compare a grayscale value and a grayscale gradient of each pixel in the edge finding frame area with B and T respectively based on a row-by-row or column-by-column search method, where only points that satisfy both grayscale value A (x, y)≥B and gradient G (x, y)≥T are edge points, and other points are non-edge points. The threshold T ranges from 0.1 to 0.95; the boundary strength B for extracting the trademark edge ranges from 1 to 200; the boundary strength B for extracting the indentation edge on the trademark ranges from 32 to 59; and the boundary strength B for extracting the printed pattern edge on the trademark ranges from 1 to 76.

S2.4: Perform fitting according to the least squares method based on coordinate points (x₁, y₁), (x₂, y₂), . . . , and (xₘ, yₘ) of the trademark edge, the indentation edge on the trademark, and the printed pattern edge on the trademark extracted by using the Sobel operator, where a regression equation of the least squares method is:

$$\hat{y} = \hat{a} + \hat{b} x ; \qquad ( 8 )$$

where the least squares method is used to minimize the sum of squares of deviations of yᵢ and a+bxᵢ, to obtain:

$$\hat{b} = \frac{{\sum }_{i = 1}^{m} ( {x}_{i} - \overline{x} ) ( {y}_{i} - \overline{y} )}{{\sum }_{i = 1}^{m} {( {x}_{i} - \overline{x} )}^{2}} , \hat{a} = \overline{y} - \hat{b} \overline{x} ; \qquad ( 9 )$$

$$\overline{y} = \frac{1}{m} ( {y}_{1} + {y}_{2} + … + {y}_{m} ) \qquad ( 10 )$$

$$\overline{x} = \frac{1}{m} ( {x}_{1} + {x}_{2} + … + {x}_{m} )$$

Through formula (1) to formula (10), a straight line of each trademark edge, each indentation edge on the trademark, and each printed pattern edge on the trademark can be fitted, after first linear regression analysis, a pixel distance from each point to the fitted straight line is calculated, that is, the burr size, the burr size ranges from 1 pixel to 50 pixels, and a suitable value is selected to remove discrete points with large distances.

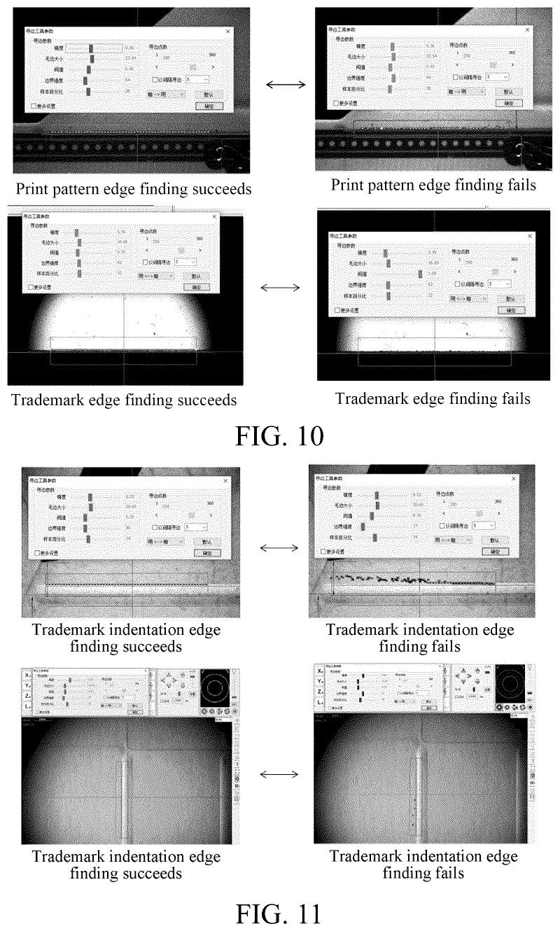

FIG. 10 and FIG. 11 are diagrams of comparison between successful edge finding examples and failed edge finding examples of trademarks, trademark indentations, and trademark patterns. “x” is edge points of the trademark and trademark pattern extracted during edge finding. Edge finding is successful when the edge points can be connected and fitted into a straight line.

S3: Extract information: transversely place the top of the to-be-detected trademark to the left in an image collection area, set a moving path of an edge finding frame of the CCD camera based on a database model, and collect a to-be-detected trademark image with the CCD camera in row-by-row search and track from the left to the right, to extract a trademark and a printed pattern edge.

A combined LED light source is used for image collection in step S2 and step S3. The combined LED light source includes a top light source arranged around the CCD camera and a bottom light source arranged below the image collection area. The top light source is used to extract the printed pattern edge and a light source intensity coefficient of the top light source is between 31 and 77. The bottom light source is used to extract the trademark edge and a light source intensity coefficient of the bottom light source is between 25 and 60.

FIG. 12 is a diagram of comparison between successful edge finding examples and failed edge finding examples of trademarks and trademark printed patterns when a light source direction and a light source intensity coefficient are appropriate. “x” is edge points of the trademark and trademark pattern extracted during edge finding. Edge finding is successful when the edge points can be connected and fitted into a straight line.

S4: Perform quality determination. As shown in FIG. 14, the top of a pack trademark is transversely placed to the left, and the trademark is divided into 6 detection positions according to pattern edges and grayscale differences, that is, D1 to D6. A corresponding printed pattern on the trademark is divided into left, middle, and right areas according to positions of folding to form a pack, that is, an area 1, an area 2, and an area 3 in FIG. 10. Distances between the boundaries of the six detection positions in FIG. 10 are calculated based on the detection data. D1 is a distance between the upper side of the printed pattern in area 1 and the trademark boundary; D2 is a distance between the lower side of the printed pattern in the area 1 and the trademark boundary; D3 is a distance between the upper side of the printed pattern in the area 2 and the trademark boundary; D4 is the distance between the lower side of the printed pattern in the area 2 and the trademark boundary; D5 is the distance between the upper side of the printed pattern in the area 3 and the trademark boundary; and D6 is the distance between the lower side of the printed pattern in the area 3 and the trademark boundary. Print quality defects are determined according to the following calculation:

$$\{ \begin{matrix}{dis}_{12} = \vert {D}_{1} - {D}_{2} \vert \\ {dis}_{34} = \vert {D}_{3} - {D}_{4} \vert \\ {dis}_{56} = \vert {D}_{5} - {D}_{6} \vert\end{matrix} \qquad ( I )$$

$$\{ \begin{matrix}{dis}_{15} = \vert {D}_{1} - {D}_{5} \vert \\ {dis}_{26} = \vert {D}_{2} - {D}_{6} \vert\end{matrix} \qquad ( 1 )$$

In formula (1), dis₁₂ represents a deviation degree of an upper pack lid layout pattern, dis₃₄ represents a deviation degree of a pack back layout pattern, and dis₅₆ represents a deviation degree of a lower pack lid layout pattern. In formula (2), dis₁₅ and dis₂₆ are the overall skewness degree of the printed pattern. According to the quality requirements required in actual cigarette production, a pattern deviation threshold ε₁ and an overall skewness degree ε₂ of the printed pattern are set to evaluate quality defects. ε₁ is 0.2 mm, and ε₂ is 0.1 mm. According to the above method, 23 samples are selected from a batch of pack trademarks for detection. Results are shown in the table below:

Printed pattern deviation of pack trademark (unit: mm)

| | D₁ | D₂ | dis₁₂ | D₃ | D₄ | dis₃₄ | D₅ | D₆ | dis₅₆ |
|---|---|---|---|---|---|---|---|---|---|
| Sample 1 | 12.56 | 12.50 | 0.06 | 12.45 | 12.57 | 0.12 | 12.40 | 12.70 | 0.30 |
| Sample 2 | 12.54 | 12.58 | 0.04 | 12.53 | 12.59 | 0.06 | 12.55 | 12.55 | 0.00 |
| Sample 3 | 12.99 | 12.60 | 0.39 | 12.89 | 12.64 | 0.25 | 12.85 | 12.79 | 0.06 |
| Sample 4 | 12.88 | 12.70 | 0.18 | 12.83 | 12.67 | 0.16 | 12.87 | 12.68 | 0.19 |
| Sample 5 | 12.60 | 12.99 | 0.39 | 12.46 | 12.98 | 0.52 | 12.52 | 13.02 | 0.50 |
| Sample 6 | 12.59 | 12.99 | 0.40 | 12.46 | 12.97 | 0.51 | 12.51 | 13.02 | 0.50 |
| Sample 7 | 12.83 | 12.31 | 0.52 | 12.72 | 12.36 | 0.36 | 12.57 | 12.49 | 0.08 |
| Sample 8 | 12.70 | 12.88 | 0.18 | 12.61 | 12.85 | 0.24 | 12.79 | 12.86 | 0.07 |
| Sample 9 | 12.98 | 12.65 | 0.33 | 12.89 | 12.68 | 0.21 | 12.83 | 12.80 | 0.03 |
| Sample 10 | 12.91 | 12.70 | 0.21 | 12.83 | 12.66 | 0.17 | 12.89 | 12.66 | 0.23 |
| Sample 11 | 12.49 | 12.57 | 0.08 | 12.40 | 12.62 | 0.22 | 12.38 | 12.71 | 0.33 |
| Sample 12 | 12.65 | 12.31 | 0.34 | 12.59 | 12.40 | 0.19 | 12.53 | 12.53 | 0.00 |
| Sample 13 | 12.63 | 12.42 | 0.21 | 12.51 | 12.49 | 0.02 | 12.40 | 12.65 | 0.25 |
| Sample 14 | 12.62 | 12.44 | 0.18 | 12.51 | 12.50 | 0.01 | 12.48 | 12.62 | 0.14 |
| Sample 15 | 12.73 | 12.34 | 0.39 | 12.60 | 12.41 | 0.19 | 12.57 | 12.54 | 0.03 |
| Sample 16 | 12.49 | 12.61 | 0.12 | 12.35 | 12.68 | 0.33 | 12.24 | 12.81 | 0.57 |
| Sample 17 | 12.49 | 12.62 | 0.13 | 12.36 | 12.62 | 0.26 | 12.40 | 12.60 | 0.20 |
| Sample 18 | 12.43 | 12.67 | 0.24 | 12.34 | 12.66 | 0.32 | 12.39 | 12.64 | 0.25 |
| Sample 19 | 12.36 | 12.73 | 0.37 | 12.25 | 12.73 | 0.48 | 12.36 | 12.70 | 0.34 |
| Sample 20 | 12.88 | 12.69 | 0.19 | 12.81 | 12.70 | 0.11 | 12.76 | 12.80 | 0.04 |
| Sample 21 | 12.48 | 12.54 | 0.06 | 12.30 | 12.58 | 0.28 | 12.34 | 12.64 | 0.30 |
| Sample 22 | 12.49 | 12.57 | 0.08 | 12.39 | 12.56 | 0.17 | 12.42 | 12.57 | 0.15 |
| Sample 23 | 12.54 | 12.54 | 0.00 | 12.54 | 12.64 | 0.10 | 12.37 | 12.78 | 0.41 |

Overall printed pattern skewness of pack trademark (unit: mm)

| | D₁ | D₅ | dis₁₅ | D₂ | D₆ | dis₂₆ |
|---|---|---|---|---|---|---|
| Sample 1 | 12.56 | 12.40 | 0.16 | 12.50 | 12.70 | 0.20 |
| Sample 2 | 12.54 | 12.55 | 0.01 | 12.58 | 12.55 | 0.03 |
| Sample 3 | 12.99 | 12.85 | 0.14 | 2.60 | 12.79 | 0.19 |
| Sample 4 | 12.88 | 12.87 | 0.01 | 12.70 | 12.68 | 0.02 |
| Sample 5 | 12.60 | 12.52 | 0.08 | 12.99 | 13.02 | 0.03 |
| Sample 6 | 12.59 | 12.51 | 0.08 | 12.99 | 13.02 | 0.03 |
| Sample 7 | 12.83 | 12.57 | 0.26 | 13.31 | 12.49 | 0.18 |
| Sample 8 | 12.70 | 12.79 | 0.09 | 12.88 | 12.86 | 0.02 |
| Sample 9 | 12.98 | 12.83 | 0.15 | 12.65 | 12.80 | 0.15 |
| Sample 10 | 12.91 | 12.89 | 0.02 | 12.70 | 12.66 | 0.04 |
| Sample 11 | 12.49 | 12.38 | 0.11 | 12.57 | 12.71 | 0.14 |
| Sample 12 | 12.65 | 12.53 | 0.12 | 13.31 | 12.53 | 0.22 |
| Sample 13 | 12.63 | 12.40 | 0.23 | 12.42 | 12.65 | 0.23 |
| Sample 14 | 12.62 | 12.48 | 0.14 | 12.44 | 12.62 | 0.18 |
| Sample 15 | 12.73 | 12.57 | 0.16 | 12.34 | 12.54 | 0.20 |
| Sample 16 | 12.49 | 12.24 | 0.25 | 12.61 | 12.81 | 0.20 |
| Sample 17 | 12.49 | 12.40 | 0.09 | 12.62 | 12.60 | 0.02 |
| Sample 18 | 12.43 | 12.39 | 0.04 | 12.67 | 12.64 | 0.03 |
| Sample 19 | 12.36 | 12.36 | 0.00 | 1.73 | 12.70 | 0.03 |
| Sample 20 | 12.88 | 12.76 | 0.12 | 12.69 | 12.80 | 0.11 |
| Sample 21 | 12.48 | 12.34 | 0.14 | 12.54 | 12.64 | 0.10 |
| Sample 22 | 12.49 | 12.42 | 0.07 | 12.57 | 12.57 | 0.00 |
| Sample 23 | 12.54 | 12.37 | 0.17 | 12.54 | 12.78 | 0.24 |

S5: Eliminate an unqualified batch. It can be seen from the detection results that the deviation of samples 2, 4, and 22 is within a tolerance threshold, and it can be determined that the overall pattern printing is in good condition. The remaining samples exceed the tolerance threshold, there are printed pattern quality defects, and the unqualified print quality ratio among the detected samples accounts for 10% or more. It is determined that this batch of pack trademarks is unqualified and the use of raw materials of this batch of trademarks causes defective cigarette packs. Before production, raw materials of this batch of trademarks are eliminated.

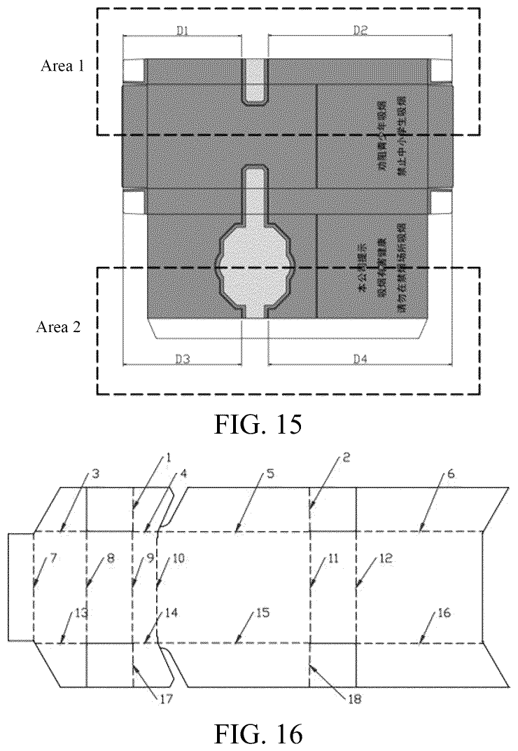

The above method is used to determine the print quality defects of the carton trademark. The pack trademark is replaced with the carton trademark. As shown in FIG. 15, the top of the carton trademark is transversely placed to the left, and the trademark is divided into 4 detection positions according to pattern edges and grayscale differences, that is, D1 to D4. A corresponding printed pattern on the carton trademark is divided into upper and lower areas according to positions of folding to form a pack, that is, an area 1 and an area 2. Distances between the boundaries of the 4 detection positions are calculated based on the detection data. D1 is a distance between the left side of the printed pattern in area 1 and the carton trademark boundary; D2 is a distance between the right side of the printed pattern in the area 1 and the carton trademark boundary; D3 is a distance between the left side of the printed pattern in the area 2 and the carton trademark boundary; and D4 is the distance between the right side of the printed pattern in the area 2 and the carton trademark boundary. Print quality defects are determined according to the following calculation.

$$\{ \begin{matrix}d i {s}_{13} = \vert {D}_{1} - {D}_{3} \vert \\ {dis}_{24} = \vert {D}_{2} - {D}_{4} \vert\end{matrix} \qquad ( 3 )$$

In formula (3), dis₁₃ and dis₂₄ are the overall skewness degree of the printed pattern. According to the quality requirements required in actual cigarette production, an overall skewness degree ε of the printed pattern of the carton trademark is set to evaluate quality defects, and ε is 0.1 mm. dis₁₃ and dis₂₄ should be less than or equal to ε. According to the above method, 20 samples are selected from a batch of carton trademarks for detection. Results are shown in the table below:

Overall printed pattern skewness of carton trademark (unit: mm)

| | D₁ | D₃ | dis₁₃ | D₂ | D₄ | dis₂₄ |
|---|---|---|---|---|---|---|
| Sample 1 | 132.78 | 132.86 | 0.08 | 172.00 | 172.03 | 0.04 |
| Sample 2 | 132.83 | 132.87 | 0.03 | 172.12 | 172.13 | 0.01 |
| Sample 3 | 132.84 | 132.90 | 0.05 | 172.05 | 172.14 | 0.09 |
| Sample 4 | 132.85 | 132.84 | 0.01 | 172.01 | 172.09 | 0.09 |
| Sample 5 | 132.80 | 132.84 | 0.05 | 172.13 | 172.00 | 0.14 |
| Sample 6 | 132.83 | 132.86 | 0.03 | 172.07 | 172.13 | 0.06 |
| Sample 7 | 132.90 | 132.81 | 0.08 | 171.99 | 172.08 | 0.09 |
| Sample 8 | 132.89 | 132.88 | 0.01 | 172.18 | 172.02 | 0.16 |
| Sample 9 | 132.79 | 132.82 | 0.03 | 172.05 | 172.17 | 0.11 |
| Sample 10 | 132.86 | 132.85 | 0.01 | 172.19 | 172.08 | 0.11 |
| Sample 11 | 132.84 | 132.89 | 0.05 | 172.12 | 172.18 | 0.06 |
| Sample 12 | 132.85 | 132.81 | 0.04 | 172.07 | 172.05 | 0.02 |
| Sample 13 | 132.84 | 132.87 | 0.03 | 172.12 | 172.04 | 0.09 |
| Sample 14 | 132.87 | 132.86 | 0.01 | 172.18 | 172.07 | 0.11 |
| Sample 15 | 132.81 | 132.81 | 0.00 | 172.19 | 172.04 | 0.15 |
| Sample 16 | 132.81 | 132.83 | 0.01 | 172.11 | 172.14 | 0.03 |
| Sample 17 | 132.79 | 132.80 | 0.01 | 172.19 | 171.99 | 0.19 |
| Sample 18 | 132.89 | 132.88 | 0.01 | 172.09 | 172.10 | 0.01 |
| Sample 19 | 132.85 | 132.88 | 0.04 | 172.12 | 172.13 | 0.02 |
| Sample 20 | 132.86 | 132.79 | 0.07 | 172.11 | 172.14 | 0.02 |

It can be seen from the detection results that the dis₂₄ deviation of samples 5, 8, 9, 10, 14, 15, and 17 exceeds a tolerance threshold, and it can be determined that the overall pattern printing is unqualified. Printed pattern quality of the remaining samples is fine, and the unqualified print quality ratio among the detected samples accounts for 35% and exceeds 10%. It is determined that this batch of carton trademarks is unqualified and the use of raw materials of this batch of carton trademarks causes defective cigarette packs. Before production, raw materials of this batch of carton trademarks are eliminated.

The method in this specification can be used to objectively detect and evaluate the print quality of trademarks from two dimensions: the printed pattern deviation degree and the overall pattern skewness degree. It can effectively guide trademark manufacturers to improve the production process and print quality in a targeted manner, thereby reducing defective cigarette packs in cigarette production, reducing the risk of market quality complaints, and at the same time reducing the consumption of labor and materials.

### Embodiment 2: Determination of Trademark Indentation Width Quality

For steps S1 and S2, refer to Embodiment 1.

S3: Extract information: transversely place the top of a to-be-detected trademark to the left in an image collection area, set a moving path of an edge finding frame of a CCD camera based on a database model, and collect a to-be-detected trademark image with the CCD camera in row-by-row search and track from top to bottom and from the left to the right, to extract a to-be-detected indentation edge.

A combined LED light source is installed around the CCD camera, including a top upper light source, a top lower light source, a top left light source, and a top right light source. The combined LED light source is used in combination with the CCD camera to collect images in steps S2 and S3. When collecting images, the light source intensity coefficient is between 31 and 49. The four light sources all irradiate at an angle of 45° toward the center of the edge finding frame of the CCD camera on the trademark. When measuring an upper edge of a transverse indentation, only the top upper light source is turned on; when measuring a lower edge of the transverse indentation, only the top lower light source is turned on; when measuring a left edge of a longitudinal indentation, only the top left light source is turned on; and when measuring a right edge of the longitudinal indentation, only the top right light source is turned on.

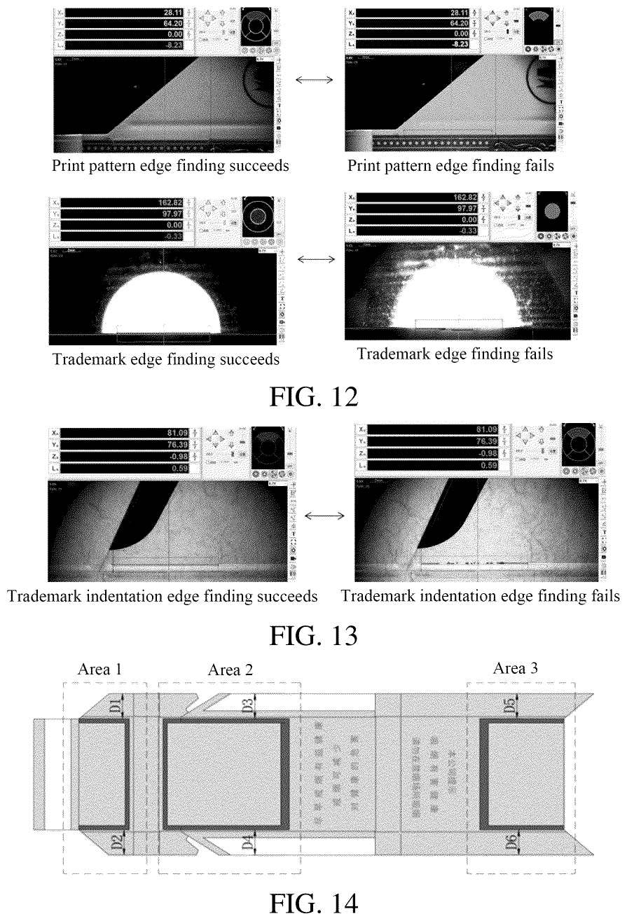

FIG. 13 is a diagram of comparison between successful edge finding examples and failed edge finding examples of a trademark indentation when a light source direction and a light source intensity coefficient are appropriate. “x” is edge points of the trademark indentation extracted during edge finding. Edge finding is successful when the edge points can be connected and fitted into a straight line.

S4: Perform quality determination: obtain a width of each indentation based on a distance between two side edges of the indentation, compare the width of each indentation with an internal control value, and determine the width quality of each indentation. Then, all indentations are divided into a critical indentation group and a non-critical indentation group based on the impact of each indentation on trademark gluing and forming effect. As shown in FIG. 16, indentations 3, 13, 4, 14, 5, 15, 6, and 16 are in a folding position for gluing. If they are not folded properly, the gluing is not strong. When indentations 8, 9, 10, 11, and 12 are at critical positions for cigarette pack forming in the figure, if they are not folded properly, defects such as the exposed lid and inconsistent upper and lower widths appear after the cigarette pack is formed. Therefore, indentations 3, 13, 4, 14, 5, 15, 6, 16, 8, 9, 10, 11, and 12 are divided into a critical indentation group. The remaining indentations 1, 2, 7, 17, and 18 are not in the critical positions of gluing and packaging and do not greatly affect the gluing and forming effects, and are divided into the non-critical indentation group. If the critical indentation group includes one indentation with a depth exceeding an internal control range, it is determined that the trademark indentation width quality fails, and if the non-critical indentation group includes more than two indentations with depths exceeding the internal control range, it is determined that the trademark indentation width quality fails.

The above method is used to detect the indentation width of three samples sampled from a batch of pack trademarks. Detection results are shown in the following table:

Sampling detection results of pack trademark (unit: mm)

| | Mean | Minimum | Maximum | | | |
|---|---|---|---|---|---|---|
| Indentation | internal | internal | internal | | | |
| serial | control | control | control | Sample | Sample | Sample |
| number | value | value | value | 1 | 2 | 3 |
| 1 | 1.40 | 1.39 | 1.40 | 1.41 | 1.39 | 1.40 |
| 2 | 1.39 | 1.35 | 1.43 | 1.40 | 1.37 | 1.39 |
| 3 | 1.43 | 1.41 | 1.44 | 1.43 | 1.42 | 1.43 |
| 4 | 1.41 | 1.40 | 1.43 | 1.42 | 1.42 | 1.42 |
| 5 | 1.41 | 1.40 | 1.42 | 1.41 | 1.41 | 1.41 |
| 6 | 1.42 | 1.41 | 1.44 | 1.43 | 1.42 | 1.42 |
| 7 | 1.41 | 1.41 | 1.42 | 1.42 | 1.42 | 1.42 |
| 8 | 1.42 | 1.41 | 1.43 | 1.43 | 1.43 | 1.41 |
| 9 | 1.41 | 1.40 | 1.41 | 1.40 | 1.40 | 1.41 |
| 10 | 1.38 | 1.37 | 1.40 | 1.40 | 1.38 | 1.39 |
| 11 | 1.40 | 1.39 | 1.41 | 1.39 | 1.39 | 1.40 |
| 12 | 1.40 | 1.39 | 1.40 | 1.39 | 1.37 | 1.40 |
| 13 | 1.43 | 1.41 | 1.44 | 1.42 | 1.43 | 1.44 |
| 14 | 1.40 | 1.39 | 1.41 | 1.40 | 1.40 | 1.39 |
| 15 | 1.42 | 1.41 | 1.43 | 1.41 | 1.41 | 1.42 |
| 16 | 1.43 | 1.41 | 1.44 | 1.42 | 1.40 | 1.43 |
| 17 | 1.37 | 1.36 | 1.38 | 1.39 | 1.37 | 1.36 |
| 18 | 1.37 | 1.36 | 1.38 | 1.38 | 1.38 | 1.37 |

S5: Eliminate an unqualified batch. It can be seen according to the detection results that sample 1 and sample 3 are trademarks with qualified indentation widths, while sample 2 is unqualified. When the unqualified indentation width ratio of the detected samples accounts for 10% or more, it is determined that the batch of trademarks is unqualified. Therefore, raw materials of this batch of trademarks cause the production of defective cigarette packs, and raw materials of this batch of trademarks can be eliminated before production. If there are too many trademarks in this batch, the number of samples should be appropriately increased for detection and determination again.

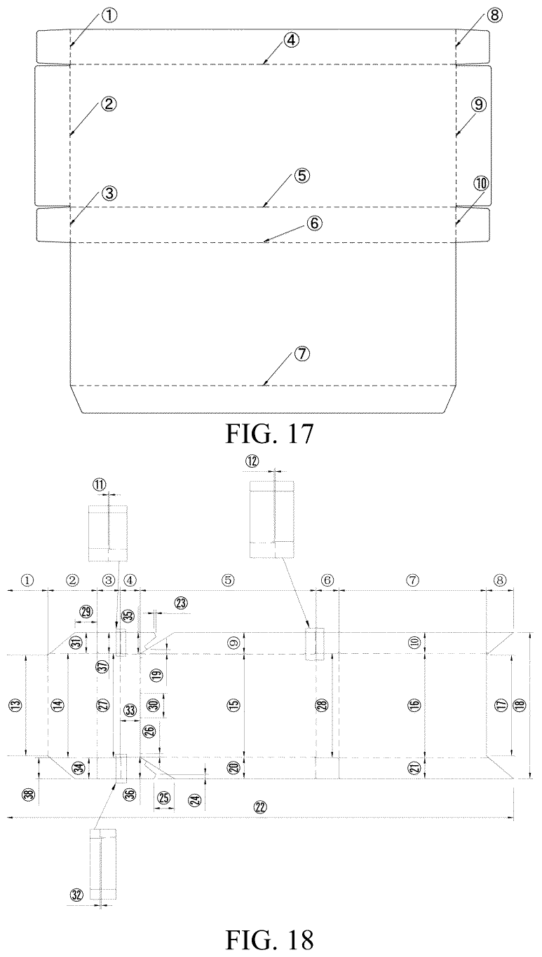

The above trademark indentation width detection method is used to detect a specific type of carton trademark. The basic image of this type of carton trademark and to-be-detected indentations of this type of carton trademark are shown in FIG. 17, including to-be-detected indentations numbered 1 to 10. Indentations 2 and 9 are in the gluing position. If they are not folded properly, the gluing is not strong. Indentations 4, 5, 6, and 7 are in the critical positions of the carton forming. If they are not folded properly, there are defects such as carton forming is poor and glass paper wrapping in the carton is not sufficiently tight. Therefore, the critical indentation group includes indentations numbered 2, 4, 5, 6, 7, and 9. The indentations 1, 3, 8, and 10 are short, and their folding positions are relatively fixed and have little impact on the carton forming effect. Therefore, they belong to the non-critical indentation group. Three sample carton trademarks are sampled from a batch for detection. Detection results are shown in the table below:

Sampling detection results of carton trademark (unit: mm)

| | Averaget | Minimum | Maximum | | | |
|---|---|---|---|---|---|---|
| Indentation | internal | internal | inernal | | | |
| serial | control | control | control | Sample | Sample | Sample |
| number | value | value | value | 1 | 2 | 3 |
| 1 | 1.18 | 1.13 | 1.24 | 1.19 | 1.11 | 1.23 |
| 2 | 1.19 | 1.12 | 1.26 | 1.23 | 1.19 | 1.24 |
| 3 | 1.18 | 1.11 | 1.26 | 1.21 | 1.23 | 1.18 |
| 4 | 1.18 | 1.12 | 1.24 | 1.23 | 1.21 | 1.18 |
| 5 | 1.25 | 1.14 | 1.37 | 1.25 | 1.26 | 1.25 |
| 6 | 1.17 | 1.10 | 1.24 | 1.20 | 1.22 | 1.24 |
| 7 | 1.22 | 1.10 | 1.33 | 1.28 | 1.28 | 1.20 |
| 8 | 1.26 | 1.18 | 1.34 | 1.21 | 1.23 | 1.28 |
| 9 | 1.25 | 1.17 | 1.34 | 1.20 | 1.22 | 1.21 |
| 10 | 1.26 | 1.18 | 1.33 | 1.25 | 1.15 | 1.21 |

It can be seen according to the detection results that samples 1 and 3 are carton trademarks with qualified indentation widths. Indentation 1 and indentation 10 in sample 2 are not within the internal control range, but indentation 1 and indentation 10 are non-critical indentations and only two indentations are not within the internal control range. Therefore, sample 2 is also a carton trademark with a qualified indentation width. The three samples in this batch are all carton trademarks with qualified indentation widths. Therefore, this batch of carton trademarks are qualified and are expected to have good machine adaptability and can enter the production process. If there are too many trademarks in this batch, the number of samples should be appropriately increased for detection and determination again.

### Embodiment 3: Determination of Trademark Die-Cut Size Quality

For steps S1 and S2, refer to Embodiment 1.

S3: Extract information: transversely place the top of the to-be-detected trademark to the left in an image collection area, set a moving path of an edge finding frame of the CCD camera based on a database model, and collect a to-be-detected trademark image with the CCD camera in row-by-row search and track from the left to the right, to extract a trademark and an indentation edge on the trademark.

A combined LED light source is used for image collection in step S2 and step S3. The combined LED light source includes a top light source arranged around the CCD camera and a bottom light source arranged below the image collection area. The top light source is used to extract the upper indentation edge of the trademark. The top light source includes a top upper light source, a top lower light source, a top left light source, and a top right light source. The four light sources all irradiate at an angle of 45° toward the center of the edge finding frame of the CCD camera on the trademark. When measuring an upper edge of a transverse indentation, only the top upper light source is turned on; when measuring a lower edge of the transverse indentation, only the top lower light source is turned on; when measuring a left edge of a longitudinal indentation, only the top left light source is turned on; and when measuring a right edge of the longitudinal indentation, only the top right light source is turned on. A light source intensity coefficient of the top light source is between 31 and 77. The bottom light source is used to extract the trademark edge and a light source intensity coefficient of the bottom light source is between 25 and 60.

S4: Perform quality determination. As shown in FIG. 18, the sizes of parts that affect the effect of trademark packaging and forming are marked as 38 detection sequences. A correspondence between the extracted edge data and each detection sequence is established. If both ends of the detection sequence are adjacent to an indentation, half the width of the adjacent indentation is included in the detection sequence. All detection sequences are divided into a critical detection sequence group and a non-critical detection sequence group. Detection sequences at the gluing folding position belong to the critical detection sequence group, and the remaining belongs to the non-critical detection sequence group. The non-critical detection sequence group includes detection sequences 1, 4, 9, 11, 12, 13, 19, 20, 23, 24, 25, 27, 30, 32, 33, 34, 35, 36, and 37; and the critical detection sequence group includes detection sequences 2, 3, 5, 6, 7, 8, 10, 14, 15, 16, 17, 18, 21, 22, 26, 28, 29, 31, and 38. The size of each detection sequence is calculated and the size of each detection sequence is compared with the internal control value. If the critical detection sequence group includes one detection sequence with a size exceeding the internal control range, it is determined that the trademark die-cut size is unqualified. If the non-critical detection sequence group includes more than two detection sequences with sizes exceeding the internal control range, it is determined that the trademark die-cut size is unqualified.

S5: Eliminate an unqualified batch: determine the trademark die-cut size quality based on the above results. When the single unqualified rate among this batch of detection samples accounts for 10% or more, it is determined that this batch of trademarks is unqualified and this batch of trademarks is eliminated from the production raw materials.

The above trademark die-cut size quality detection method is used to detect ten samples of pack trademarks. The detection results are shown in the following table:

Sampling detection results of pack trademark (unit: mm)

| | Average | Minimum | Maximum | | | | | | | | | | |
|---|---|---|---|---|---|---|---|---|---|---|---|---|---|
| Detection | internal | internal | internal | | | | | | | | | | |
| serial | control | control | control | sample | Sample | Sample | Sample | Sample | Sample | Sample | Sample | Samsam | Samsam |
| number | value | value | value | 1 | 2 | 3 | 4 | 5 | 6 | 7 | 8 | 9 | 10 |
| 1 | 21.58 | 21.48 | 21.71 | 21.62 | 21.63 | 21.65 | 21.66 | 21.65 | 21.63 | 21.56 | 21.58 | 21.59 | 21.6 |
| 2 | 26.04 | 26.03 | 26.05 | 26.02 | 26.04 | 26.02 | 26.02 | 26.04 | 26.04 | 26.03 | 26.03 | 26.02 | 26.03 |
| 3 | 12.04 | 12.03 | 12.05 | 12.03 | 12.03 | 12.03 | 12.02 | 12.03 | 12.04 | 12.03 | 12.03 | 12.03 | 12.03 |
| 4 | 10.52 | 10.51 | 10.54 | 10.52 | 10.52 | 10.52 | 10.52 | 10.51 | 10.53 | 10.49 | 10.52 | 10.49 | 10.48 |
| 5 | 92.51 | 92.47 | 92.54 | 92.51 | 92.5 | 92.5 | 92.51 | 92.51 | 92.49 | 92.53 | 92.54 | 92.53 | 92.53 |
| 6 | 12.05 | 12.02 | 12.07 | 12.05 | 12.05 | 12.04 | 12.04 | 12.04 | 12.04 | 12.05 | 12.04 | 12.04 | 12.03 |
| 7 | 77.50 | 77.41 | 77.59 | 77.35 | 77.45 | 77.39 | 77.39 | 77.42 | 77.55 | 77.44 | 77.42 | 77.4 | 77.38 |
| 8 | 14.39 | 14.27 | 14.47 | 14.28 | 14.3 | 14.29 | 14.24 | 14.3 | 14.4 | 14.34 | 14.3 | 14.37 | 14.48 |
| 9 | 11.25 | 11.20 | 11.32 | 11.34 | 11.32 | 11.31 | 11.32 | 11.31 | 11.25 | 11.28 | 11.27 | 11.26 | 11.26 |
| 10 | 10.99 | 10.94 | 11.04 | 11.11 | 11 | 11.1 | 11.06 | 11 | 11.02 | 11.04 | 11.02 | 11.03 | 11.05 |
| 11 | 0.23 | 0.21 | 0.23 | 0.23 | 0.22 | 0.22 | 0.22 | 0.22 | 0.22 | 0.2 | 0.22 | 0.2 | 0.19 |
| 12 | 0.24 | 0.21 | 0.26 | 0.28 | 0.23 | 0.28 | 0.29 | 0.25 | 0.25 | 0.26 | 0.25 | 0.27 | 0.27 |
| 13 | 52.98 | 52.90 | 53.05 | 53.03 | 53.05 | 53.06 | 53.07 | 53.05 | 53 | 53.05 | 53.05 | 53.06 | 53.03 |
| 14 | 55.09 | 55.05 | 55.16 | 55.06 | 55.05 | 55.05 | 55.06 | 55.05 | 55.08 | 55.09 | 55.09 | 55.11 | 55.09 |
| 15 | 54.52 | 54.47 | 54.55 | 54.51 | 54.51 | 54.51 | 54.5 | 54.51 | 54.49 | 54.51 | 54.52 | 54.51 | 54.5 |
| 16 | 55.05 | 54.99 | 55.11 | 54.97 | 54.99 | 54.97 | 54.97 | 54.99 | 55.05 | 55 | 55 | 55 | 54.99 |
| 17 | 53.11 | 52.94 | 53.25 | 53.02 | 53.06 | 53.1 | 53.1 | 53.15 | 53.13 | 53.01 | 53.04 | 52.99 | 53.12 |
| 18 | 77.07 | 76.97 | 77.14 | 77.02 | 77.04 | 77.05 | 77.01 | 77.02 | 77.09 | 77.06 | 77.02 | 77.06 | 77.05 |
| 19 | 2.08 | 1.97 | 2.21 | 2.12 | 2.16 | 2.17 | 2.18 | 2.2 | 2.2 | 2.11 | 2.07 | 2.08 | 2.12 |
| 20 | 11.32 | 11.26 | 11.38 | 11.23 | 11.26 | 11.3 | 11.29 | 11.27 | 11.33 | 11.35 | 11.31 | 11.32 | 11.33 |
| 21 | 11.03 | 10.99 | 11.08 | 10.95 | 11.02 | 10.99 | 10.99 | 10.99 | 11.05 | 11.03 | 11 | 11.03 | 11.02 |
| 22 | 266.49 | 266.42 | 266.55 | 266.37 | 266.48 | 266.43 | 266.4 | 266.53 | 266.47 | 266.48 | 266.43 | 266.46 | 266.56 |
| 23 | 1.07 | 0.98 | 1.25 | 0.94 | 0.93 | 0.95 | 0.99 | 1 | 1.12 | 0.93 | 1.12 | 0.93 | 0.94 |
| 24 | 2.36 | 2.18 | 2.45 | 2.64 | 2.4 | 2.4 | 2.36 | 2.38 | 2.25 | 2.52 | 2.36 | 2.37 | 2.36 |
| 25 | 10.85 | 10.62 | 10.95 | 10.69 | 10.84 | 10.88 | 10.86 | 10.79 | 10.83 | 10.74 | 10.82 | 10.73 | 10.74 |
| 26 | 1.81 | 1.75 | 1.94 | 1.95 | 1.92 | 1.88 | 1.91 | 1.93 | 1.93 | 1.81 | 1.86 | 1.87 | 1.84 |
| 27 | 54.96 | 54.88 | 55.07 | 54.86 | 54.89 | 54.93 | 54.88 | 54.88 | 55.05 | 54.87 | 54.91 | 54.86 | 54.86 |
| 28 | 54.97 | 54.88 | 55.04 | 54.9 | 54.9 | 54.89 | 54.92 | 54.95 | 54.92 | 54.91 | 54.94 | 54.95 | 54.94 |
| 29 | 11.68 | 11.48 | 11.73 | 11.77 | 11.7 | 11.85 | 11.84 | 11.68 | 11.63 | 11.72 | 11.72 | 11.76 | 11.77 |
| 30 | 13.00 | 12.75 | 13.25 | 12.75 | 13.44 | 12.75 | 13.32 | 13.11 | 12.99 | 13.45 | 13.11 | 12.46 | 12.76 |
| 31 | 11.96 | 11.88 | 12.02 | 10.96 | 11.93 | 10.94 | 10.95 | 11.95 | 11.92 | 10.91 | 12 | 10.9 | 10.88 |
| 32 | 0.94 | 0.91 | 0.97 | 0.97 | 1 | 0.99 | 0.99 | 0.99 | 0.96 | 0.97 | 0.96 | 0.96 | 0.97 |
| 33 | 10.54 | 10.53 | 10.55 | 10.55 | 10.54 | 10.55 | 10.55 | 10.54 | 10.55 | 10.53 | 10.53 | 10.52 | 10.53 |
| 34 | 11.34 | 11.27 | 11.40 | 11.13 | 11.28 | 11.16 | 11.12 | 11.28 | 11.33 | 11.19 | 11.35 | 11.12 | 11.14 |
| 35 | 11.25 | 11.15 | 11.35 | 11.19 | 11.18 | 11.18 | 11.2 | 11.2 | 11.27 | 11.15 | 11.15 | 11.15 | 11.15 |
| 36 | 11.25 | 11.15 | 11.35 | 11.27 | 11.3 | 11.34 | 11.31 | 11.3 | 11.25 | 11.42 | 11.31 | 11.35 | 11.37 |
| 37 | 11.34 | 11.27 | 11.40 | 11.02 | 11.35 | 10.96 | 11.04 | 11.35 | 11.29 | 11.03 | 11.33 | 11.04 | 11.03 |
| 38 | 11.34 | 11.27 | 11.40 | 11.03 | 11.07 | 11.09 | 11.07 | 11.04 | 11.29 | 11.14 | 11.09 | 11.06 | 11.08 |

It can be seen that only sample 6 and sample 8 are qualified pack trademarks. When the single unqualified rate among samples accounts for 1000 or more, it is determined that this batch of pack trademarks is unqualified and this batch of pack trademarks cannot be used for production and is eliminated from the production raw materials.

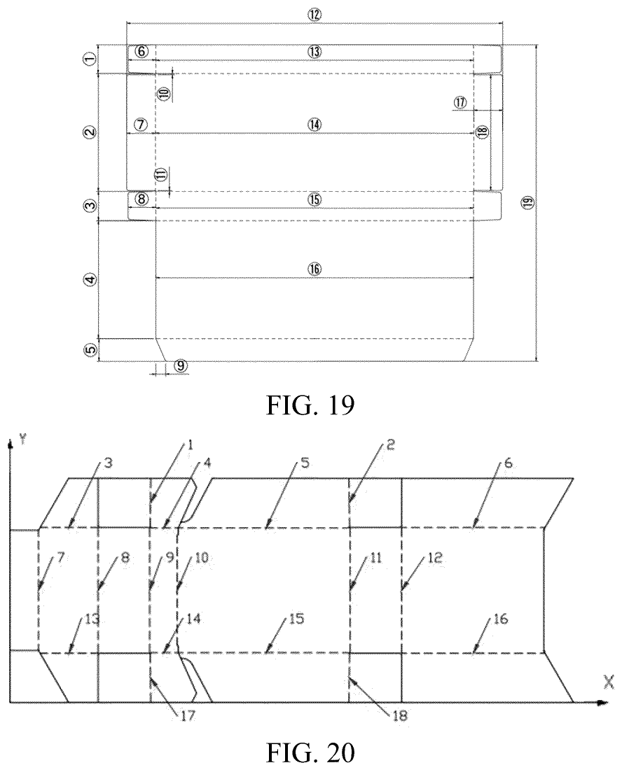

The above trademark die-cut size quality detection method is used to detect a specific type of carton trademark. The basic image of this type of carton trademark and the sizes of parts of this type of carton trademark marked as 19 detection sequences according to the effect on the trademark packaging are shown in FIG. 19. The non-critical detection sequence group includes detection sequences 6, 8, 9, 10, and 11; and the critical detection sequence group includes detection sequences 1, 2, 3, 4, 5, 7, 12, 13, 14, 15, 16, 17, 18, and 19. Ten sample carton trademarks are sampled from a batch for detection. Detection results are shown in the table below:

Sampling detection results of carton trademark (unit: mm)

| | Average | Minimum | Maximum | | | | | | | | | | |
|---|---|---|---|---|---|---|---|---|---|---|---|---|---|
| Detection | internal | internal | internal | | | | | | | | | | |
| serial | control | control | control | Sample | Sample | Sample | Sample | Sample | Sample | Sample | Sample | Sample | Sample |
| number | value | value | value | 1 | 2 | 3 | 4 | 5 | 6 | 7 | 8 | 9 | 10 |
| 1 | 25.50 | 25.25 | 25.75 | 25.49 | 25.58 | 25.54 | 25.74 | 25.56 | 25.74 | 25.63 | 25.73 | 25.56 | 25.59 |
| 2 | 104.00 | 103.75 | 104.25 | 103.94 | 103.97 | 104.03 | 103.86 | 104.20 | 104.01 | 103.82 | 103.92 | 104.11 | 104.12 |
| 3 | 26.00 | 25.75 | 26.25 | 26.03 | 25.85 | 26.12 | 25.92 | 25.85 | 25.94 | 26.16 | 25.77 | 25.80 | 26.10 |
| 4 | 104.00 | 103.75 | 104.25 | 104.16 | 104.11 | 103.97 | 104.00 | 104.10 | 103.90 | 104.03 | 103.82 | 104.07 | 103.75 |
| 5 | 20.00 | 19.75 | 20.25 | 19.87 | 20.02 | 19.89 | 20.16 | 19.93 | 20.20 | 19.82 | 20.07 | 19.86 | 20.00 |
| 6 | 24.50 | 24.25 | 24.75 | 24.20 | 24.37 | 24.57 | 24.67 | 24.66 | 24.53 | 24.34 | 24.73 | 24.70 | 24.58 |
| 7 | 25.50 | 25.25 | 25.75 | 25.67 | 25.71 | 25.63 | 25.48 | 25.46 | 25.35 | 25.69 | 25.58 | 25.42 | 25.57 |
| 8 | 24.50 | 24.25 | 24.75 | 24.68 | 24.66 | 24.44 | 24.50 | 24.68 | 24.54 | 24.69 | 24.39 | 24.34 | 24.58 |
| 9 | 8.68 | 8.43 | 8.93 | 9.01 | 9.03 | 9.21 | 8.78 | 8.80 | 8.54 | 8.59 | 8.84 | 8.61 | 8.83 |
| 10 | 1.00 | 0.75 | 1.25 | 1.26 | 1.11 | 1.03 | 1.05 | 1.02 | 1.16 | 0.89 | 1.17 | 0.89 | 1.07 |
| 11 | 1.00 | 0.75 | 1.25 | 1.22 | 1.07 | 0.91 | 0.76 | 0.77 | 0.85 | 0.85 | 1.18 | 0.99 | 1.18 |
| 12 | 332.00 | 331.75 | 332.25 | 332.20 | 331.98 | 332.08 | 332.00 | 331.97 | 332.16 | 331.99 | 331.67 | 331.99 | 331.94 |
| 13 | 280.50 | 280.25 | 280.75 | 280.66 | 280.53 | 280.39 | 280.60 | 280.36 | 280.32 | 280.31 | 280.28 | 280.67 | 280.50 |
| 14 | 281.00 | 280.75 | 281.25 | 281.54 | 280.96 | 281.03 | 281.09 | 280.78 | 280.99 | 281.18 | 280.79 | 280.88 | 281.07 |
| 15 | 280.50 | 280.25 | 280.75 | 280.34 | 280.57 | 280.57 | 280.89 | 280.29 | 280.37 | 280.47 | 280.75 | 280.42 | 280.40 |
| 16 | 280.50 | 280.25 | 280.75 | 280.46 | 280.62 | 280.48 | 280.61 | 280.46 | 280.61 | 280.42 | 280.28 | 280.51 | 280.29 |
| 17 | 25.50 | 25.25 | 25.75 | 25.41 | 25.64 | 25.50 | 25.39 | 25.30 | 25.51 | 25.42 | 25.32 | 25.67 | 25.43 |
| 18 | 102.00 | 101.75 | 102.25 | 10199 | 102.13 | 102.14 | 101.78 | 102.18 | 101.96 | 102.15 | 102.35 | 101.79 | 101.82 |
| 19 | 279.50 | 279.25 | 279.75 | 279.53 | 279.44 | 279.58 | 279.31 | 279.59 | 279.70 | 279.53 | 279.41 | 279.74 | 279.61 |

Through data comparison, it is found that die-cut sizes of sample 1, sample 2, sample 3, sample 4, and sample 8 exceed the standard, and the die-cut sizes of the remaining samples are within the internal control range. In sample 1, detection serial number 6, detection serial number 9, detection serial number 10, and detection serial number 14 exceed the internal control range. Detection serial number 6, detection serial number 9, and detection serial number 10 are non-critical items, and detection serial number 14 is a critical item. Therefore, sample 1 is the carton trademark with an unqualified die-cut size. In both sample 2 and sample 3, the detection serial number 9 exceeds the internal control range. Because the detection serial number 9 is a non-critical item, samples 2 and 3 are both carton trademarks with a qualified die-cut size. In sample 4, the detection serial number 15 exceeds the internal control range, and the detection serial number 15 is a critical item. Therefore, sample 4 is a carton trademark with an unqualified die-cut size. In sample 8, the detection serial number 12 and the detection serial number 18 exceed the internal control range, and the detection serial number 12 and the detection serial number 18 are critical items. Therefore, sample 8 is a carton trademark with an unqualified die-cut size. To sum up, 3 out of 10 samples of this batch of carton trademarks are unqualified, with a defect rate of 30%. This batch of carton trademarks cannot be used for production. This batch of carton trademarks is eliminated from the production raw materials. If there are too many trademarks in this batch, the number of samples should be appropriately increased for detection and determination again.

### Embodiment 4: Determination of Trademark Indentation Depth Quality

The CCD camera on the detection equipment is replaced with a laser detection head, the to-be-detected samples are placed on the image collection platform of the detection equipment one by one, a coordinate system is established, midpoint coordinates of each indentation and the start and end point coordinates of each indentation are entered into the indentation depth detection apparatus, and the depths of all indentations on each trademark start to be measured in sequence.

As shown in FIG. 20, the detected trademark is transversely placed. The uppermost edge of the trademark coincides with the Y-axis, and the leftmost edge of the trademark coincides with the X-axis. All indentations on the transversely placed trademark are marked as 1 to 18 from top to bottom and from left to right. Midpoint coordinates corresponding to the indentations are sequentially a (60.02, 87.08), b (147.12, 87.08), c (24.79, 76.13), d (65.02, 76.13), e (109.57, 76.13), f (198.79, 76.13), g (11.96, 49.01), h (37.62, 49.01), i (60.02, 49.01), j (72.02, 49.01), k (147.12, 49.01), 1 (169.48, 49.01), m (24.79, 22.78), n (65.02, 22.78), o (109.57, 22.78), p (198.79, 22.78), q (60.02, 10.89), and r (147.12, 10.89). When measuring distances, indentations are measured in sequence in numerical order.

When measuring each indentation depth, points are selected from a trademark surface between two points that are 5 mm away from two side edges of the indentation, a total of thirty points evenly spaced need to be selected, and a line connecting the selected points is perpendicular to the detected indentation and passes through the midpoint of the detected indentation. During specific measurement, the laser head moves from the measurement start point at one end of the indentation to the measurement endpoint at the other end. After each indentation is measured, the laser head moves in a straight line from a collection end point of the measured indentation to a collection start point of a next to-be-measured indentation, and when measuring a distance of a first indentation, a moving path of the laser head points to a second indentation.

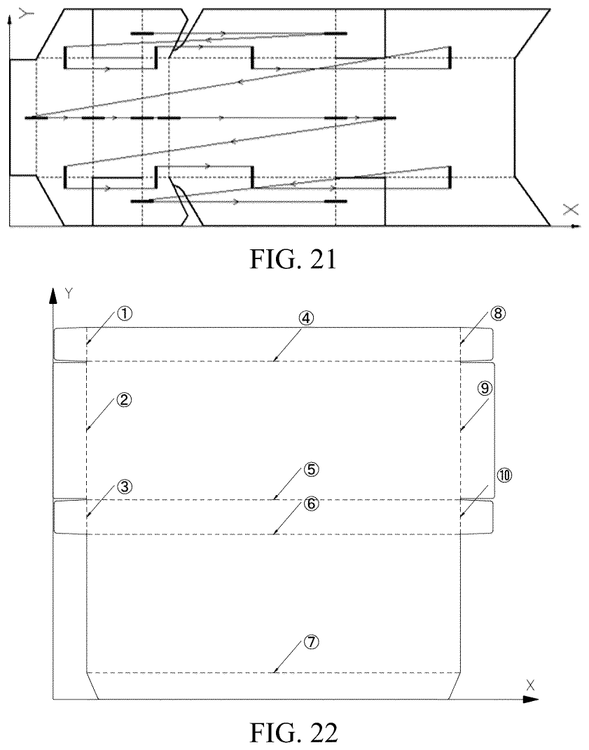

As shown in FIG. 21, in this embodiment, the moving path of the laser head sequentially measures indentations 1, 2, 3, . . . , and 18, and passes through the midpoints a, b, c, . . . , and r of indentations in sequence. During the entire detection process, the start point coordinates and end point coordinates of indentation 1 to indentation 18 and the midpoint coordinates of each indentation are shown in the following table:

Coordinate table of indentation midpoint of pack
trademark and start point of detection path

| Sampling | | | Start and end | | | |
|---|---|---|---|---|---|---|
| midpoint | X | Y | points of detection | | X | Y |
| a | 60.02 | 87.08 | 11 | (start point) | 55.02 | 87.08 |
| | | | 12 | (end point) | 65.02 | 87.08 |
| b | 147.12 | 87.08 | 21 | (start point) | 142.12 | 87.08 |
| | | | 22 | (end point) | 152.12 | 87.08 |
| c | 24.79 | 76.13 | 31 | (start point) | 24.79 | 81.13 |
| | | | 32 | (end point) | 24.79 | 81.13 |
| d | 65.02 | 76.13 | 41 | (start point) | 65.02 | 71.13 |
| | | | 42 | (end point) | 65.02 | 71.13 |
| e | 109.57 | 76.13 | 51 | (start point) | 109.57 | 81.13 |
| | | | 52 | (end point) | 109.57 | 71.13 |
| f | 198.79 | 76.13 | 61 | (start point) | 198.79 | 71.13 |
| | | | 62 | (end point) | 198.79 | 81.13 |
| g | 11.96 | 49.01 | 71 | (start point) | 6.96 | 49.01 |
| | | | 72 | (end point) | 16.96 | 49.01 |
| h | 37.62 | 49.01 | 81 | (start point) | 32.62 | 49.01 |
| | | | 82 | (end point) | 42.62 | 49.01 |
| i | 60.02 | 49.01 | 91 | (start point) | 55.02 | 49.01 |
| | | | 92 | (end point) | 65.02 | 49.01 |
| j | 72.02 | 49.01 | 101 | (start point) | 67.02 | 49.01 |
| | | | 102 | (end point) | 77.02 | 49.01 |
| k | 147.12 | 49.01 | 111 | (start point) | 142.12 | 49.01 |
| | | | 112 | (end point) | 152.12 | 49.01 |
| l | 169.48 | 49.01 | 121 | (start point) | 164.48 | 49.01 |
| | | | 122 | (end point) | 174.48 | 49.01 |
| m | 24.79 | 22.78 | 131 | (start point) | 24.79 | 27.78 |
| | | | 132 | (end point) | 24.79 | 17.78 |
| n | 65.02 | 22.78 | 141 | (start point) | 65.02 | 17.78 |
| | | | 142 | (end point) | 65.02 | 27.78 |
| o | 109.57 | 22.78 | 151 | (start point) | 109.57 | 27.78 |
| | | | 152 | (end point) | 109.57 | 17.78 |
| p | 198.79 | 22.78 | 161 | (start point) | 198.79 | 17.78 |
| | | | 162 | (end point) | 198.79 | 27.78 |
| q | 60.02 | 10.89 | 171 | (start point) | 55.02 | 10.89 |
| | | | 172 | (end point) | 65.02 | 10.89 |
| r | 147.12 | 10.89 | 181 | (start point) | 142.12 | 10.89 |
| | | | 182 | (end point) | 152.12 | 10.89 |

Among measured distances between the 30 points selected for each indentation, the depth of the indentation is determined by subtracting the minimum distance from the maximum distance. The above process is used to complete the measurement of all indentation depths of the 20 sample trademarks one by one.

Then, the average indentation depth needs to be determined, and qualified product trademarks within two months are sampled as a standard group to measure indentation depth data. The average indentation depth is obtained, to obtain table of the average indentation depths of the indentations, as shown in the following table:

Table of average indentation depth of pack trademark (unit: mm)

| | Indentation | Indentation | Indentation | Indentation | Indentation | Indentation | Indentation | Indentation | Indentation | Indentation |
|---|---|---|---|---|---|---|---|---|---|---|
| | depth1 | depth2 | depth3 | depth4 | depth5 | depth6 | depth7 | depth8 | depth9 | depth10 |
| Average | 0.09 | 0.1 | 0.06 | 0.07 | 0.06 | 0.07 | 0.1 | 0.1 | 0.1 | 0.12 |
| | | | Indentation | Indentation | Indentation | Indentation | Indentation | Indentation | Indentation | Indentation |
| | | | depth11 | depth12 | depth13 | depth14 | depth15 | depth16 | depth17 | depth18 |
| | | Average | 0.09 | 0.11 | 0.06 | 0.06 | 0.05 | 0.07 | 0.09 | 0.1 |

It can be considered that when the indentation value of the trademark is this average value, the auxiliary materials have good adaptability to the machine. Therefore, this average value is used as the standard value of the indentation depth. After determining the standard value, it is necessary to further modify the internal control range of each indentation depth value. First, the obvious outliers of the indentation data in the standard group are eliminated, that is, the measured values in the group that deviate from the average value by more than twice the standard deviation, and then the detected minimum value and maximum value are set as the upper limit value and the lower limit value of the internal control interval; and the interval between the final upper limit value and lower limit value is the internal control range. The final determined internal control range is shown in the following table:

Table of internal control range of indentation depth of pack trademark (unit: mm)

| | Indentation | Indentation | Indentation | Indentation | Indentation | Indentation | Indentation | Indentation | Indentation | Indentation |
|---|---|---|---|---|---|---|---|---|---|---|
| | depth1 | depth2 | depth3 | depth4 | depth5 | depth6 | depth7 | depth8 | depth9 | depth10 |
| Average | 0.09 | 0.1 | 0.06 | 0.07 | 0.06 | 0.07 | 0.1 | 0.1 | 0.1 | 0.12 |
| Upper | 0.11 | 0.14 | 0.09 | 0.09 | 0.07 | 0..09 | 0.12 | 0.14 | 0.12 | 0.15 |
| Lower | 0.07 | 0.07 | 0.02 | 0.05 | 0.05 | 0.05 | 0.07 | 0.09 | 0.09 | 0.1 |
| | | | Indentation | Indentation | Indentation | Indentation | Indentation | Indentation | Indentation | Indentation |
| | | | depth11 | depth12 | depth13 | depth14 | depth15 | depth16 | depth17 | depth18 |
| | | Average | 0.09 | 0.11 | 0.06 | 0.06 | 0.05 | 0.07 | 0.09 | 0.1 |
| | | Upper | 0.12 | 0.13 | 0.1 | 0.07 | 0.08 | 0.09 | 0.11 | 0.11 |
| | | Lower | 0.08 | 0.09 | 0.04 | 0.05 | 0.04 | 0.05 | 0.07 | 0.07 |

Then, all indentations are divided into a critical indentation group and a non-critical indentation group based on the impact of each indentation on trademark gluing and forming effect. Indentations 3, 13, 4, 14, 5, 15, 6, and 16 are in a folding position for gluing. If they are not folded properly, the gluing is not strong. When indentations 8, 9, 10, 11, and 12 are at critical positions for cigarette pack forming in the figure, if they are not folded properly, defects such as the exposed lid and inconsistent upper and lower widths appear after the cigarette pack is formed. Therefore, indentations 3, 13, 4, 14, 5, 15, 6, 16, 8, 9, 10, 11, and 12 are divided into a critical indentation group. The remaining indentations 1, 2, 7, 17, and 18 are not in the critical positions of gluing and packaging and do not greatly affect the gluing and forming effects, and are divided into the non-critical indentation group. If the critical indentation group includes one indentation with a depth exceeding an internal control range, it is determined that the trademark indentation depth quality fails, and if the non-critical indentation group includes more than two indentations with depths exceeding the internal control range, it is determined that the trademark indentation depth quality fails.

All indentation depth data of the 20 samples measured in this embodiment is shown in the following table:

Sample measurement data table of pack trademark (unit: mm)

| Sample | | | | | | | | | | |
|---|---|---|---|---|---|---|---|---|---|---|
| serial | Indentation | Indentation | Indentation | Indentation | Indentation | Indentation | Indentation | Indentation | Indentation | Indentation |
| number | depth1 | depth2 | depth3 | depth4 | depth5 | depth6 | depth7 | depth8 | depth9 | depth10 |
| 1 | 0.09 | 0.1 | 0.06 | 0.07 | 0.06 | 0.07 | 0.1 | 0.1 | 0.1 | 0.12 |
| 2 | 0.11 | 0.14 | 0.09 | 0.09 | 0.07 | 0.09 | 0.12 | 0.14 | 0.12 | 0.15 |
| 3 | 0.07 | 0.07 | 0.02 | 0.05 | 0.05 | 0.05 | 0.07 | 0.09 | 0.09 | 0.1 |
| 4 | 0.12 | 0.14 | 0.08 | 0.04 | 0.08 | 0.06 | 0.13 | 0.11 | 0.08 | 0.12 |
| 5 | 0.12 | 0.15 | 0.11 | 0.04 | 0.12 | 0.1 | 0.16 | 0.12 | 0.09 | 0.15 |
| 6 | 0.13 | 0.14 | 0.11 | 0.07 | 0.11 | 0.09 | 0.16 | 0.15 | 0.1 | 0.15 |
| 7 | 0.12 | 0.14 | 0.1 | 0.05 | 0.1 | 0.1 | 0.16 | 0.12 | 0.1 | 0.14 |
| 8 | 0.12 | 0.14 | 0.09 | 0.05 | 0.09 | 0.08 | 0.14 | 0.13 | 0.1 | 0.13 |
| 9 | 0.11 | 0.14 | 0.1 | 0.04 | 0.08 | 0.07 | 0.15 | 0.13 | 0.11 | 0.14 |
| 10 | 0.14 | 0.14 | 0.1 | 0.03 | 0.11 | 0.08 | 0.14 | 0.12 | 0.11 | 0.14 |
| 11 | 0.1 | 0.12 | 0.08 | 0.03 | 0.08 | 0.05 | 0.16 | 0.14 | 0.1 | 0.12 |
| 12 | 0.12 | 0.15 | 0.1 | 0.04 | 0.1 | 0.08 | 0.15 | 0.14 | 0.1 | 0.15 |
| 13 | 0.12 | 0.16 | 0.09 | 0.04 | 0.09 | 0.09 | 0.13 | 0.11 | 0.09 | 0.13 |
| 14 | 0.12 | 0.16 | 0.09 | 0.08 | 0.09 | 0.07 | 0.16 | 0.15 | 0.14 | 0.16 |
| 15 | 0.14 | 0.17 | 0.12 | 0.12 | 0.1 | 0.09 | 0.15 | 0.16 | 0.18 | 0.16 |
| 16 | 0.14 | 0.16 | 0.12 | 0.13 | 0.12 | 0.13 | 0.16 | 0.15 | 0.14 | 0.15 |
| 17 | 0.09 | 0.11 | 0.08 | 0.05 | 0.07 | 0.07 | 0.13 | 0.12 | 0.09 | 0.11 |
| 18 | 0.06 | 0.08 | 0.05 | 0.05 | 0.05 | 0.05 | 0.1 | 0.1 | 0.07 | 0.09 |
| 19 | 0.13 | 0.1 | 0.11 | 0.06 | 0.09 | 0.08 | 0.16 | 0.15 | 0.15 | 0.16 |
| 20 | 0.1 | 0.13 | 0.08 | 0.08 | 0.07 | 0.08 | 0.12 | 0.11 | 0.11 | 0.13 |
| | | Sample | | | | | | | | |
| | | serial | Indentation | Indentation | Indentation | Indentation | Indentation | Indentation | Indentation | Indentation |
| | | number | depth11 | depth12 | depth13 | depth14 | depth15 | depth16 | depth17 | depth18 |
| | | 1 | 0.09 | 0.11 | 0.06 | 0.06 | 0.05 | 0.07 | 0.09 | 0.1 |
| | | 2 | 0.12 | 0.13 | 0.1 | 0.07 | 0.08 | 0.09 | 0.11 | 0.11 |
| | | 3 | 0.08 | 0.09 | 0.04 | 0.05 | 0.04 | 0.05 | 0.07 | 0.07 |
| | | 4 | 0.13 | 0.13 | 0.07 | 0.05 | 0.03 | 0.06 | 0.08 | 0.1 |
| | | 5 | 0.15 | 0.15 | 0.06 | 0.06 | 0.05 | 0.06 | 0.07 | 0.1 |
| | | 6 | 0.12 | 0.13 | 0.07 | 0.05 | 0.05 | 0.06 | 0.1 | 0.09 |
| | | 7 | 0.12 | 0.13 | 0.07 | 0.05 | 0.05 | 0.06 | 0.09 | 0.1 |
| | | 8 | 0.13 | 0.14 | 0.07 | 0.04 | 0.05 | 0.06 | 0.09 | 0.1 |
| | | 9 | 0.13 | 0.13 | 0.07 | 0.06 | 0.06 | 0.06 | 0.09 | 0.11 |
| | | 10 | 0.13 | 0.12 | 0.07 | 0.05 | 0.06 | 0.06 | 0.1 | 0.1 |
| | | 11 | 0.1 | 0.14 | 0.07 | 0.02 | 0.07 | 0.07 | 0.1 | 0.11 |
| | | 12 | 0.12 | 0.13 | 0.08 | 0.05 | 0.05 | 0.06 | 0.09 | 0.1 |
| | | 13 | 0.14 | 0.13 | 0.05 | 0.06 | 0.05 | 0.06 | 0.09 | 0.12 |
| | | 14 | 0.15 | 0.14 | 0.08 | 0.05 | 0.06 | 0.08 | 0.08 | 0.11 |
| | | 15 | 0.14 | 0.15 | 0.07 | 0.07 | 0.06 | 0.07 | 0.11 | 0.12 |
| | | 16 | 0.14 | 0.16 | 0.08 | 0.04 | 0.05 | 0.07 | 0.12 | 0.1 |
| | | 17 | 0.1 | 0.1 | 0.05 | 0.07 | 0.04 | 0.06 | 0.09 | 0.1 |
| | | 18 | 0.08 | 0.08 | 0.04 | 0.05 | 0.04 | 0.06 | 0.09 | 0.08 |
| | | 19 | 0.12 | 0.13 | 0.06 | 0.06 | 0.04 | 0.06 | 0.1 | 0.09 |
| | | 20 | 0.12 | 0.14 | 0.07 | 0.05 | 0.06 | 0.08 | 0.11 | 0.12 |

Through data comparison, we can determine that among the 20 samples measured, and only sample 1, sample 2, and sample 3 have indentations within the internal control range, and are trademarks with qualified indentation depths. In the sample 17, only the depth of indentation 7 exceeds the internal control range, and indentation 7 belongs to the non-critical indentation group. Therefore, sample 17 also belongs to the trademark with a qualified indentation depth. The remaining samples all have indentations in the critical indentation group exceeding the internal control range.

If the defect rate of the samples reaches 1000 or above, it is determined that the batch of trademarks of the samples is unqualified. Only three of the 20 samples sampled from this batch of trademarks are qualified, with a pass rate of only 15% o. This batch of trademarks is unqualified raw materials, has poor machine adaptability, and cannot enter the production process. This batch of trademarks is eliminated from the production raw materials. If there are too many trademarks in this batch, the number of samples should be appropriately increased for detection and determination again.

The above method is used to sample and detect the carton trademark. As shown in FIG. 22, the carton trademark is placed forward in the plane rectangular coordinate system. The leftmost edge of the carton trademark coincides with the Y-axis, and the bottom edge of the carton trademark coincides with the X-axis. All the indentations on the carton trademark are marked as 1 to 10 from top to bottom from left to right. The midpoint coordinates of the indentations are a (25.75, 266.75), b (306.25, 266.75), c (166, 254), d (25.75, 202), e (306.25, 202), f (166, 150), g (25.75, 137), h (306.25, 137), i (166, 125), and j (166, 20). When measuring distances, the indentations are measured in sequence from top to bottom and from left to right. After each indentation is measured, the laser head moves in a straight line from a collection end point of the measured indentation to a collection start point of a next to-be-measured indentation, and when measuring a distance of a first indentation, a moving path of the laser head points to a second indentation.

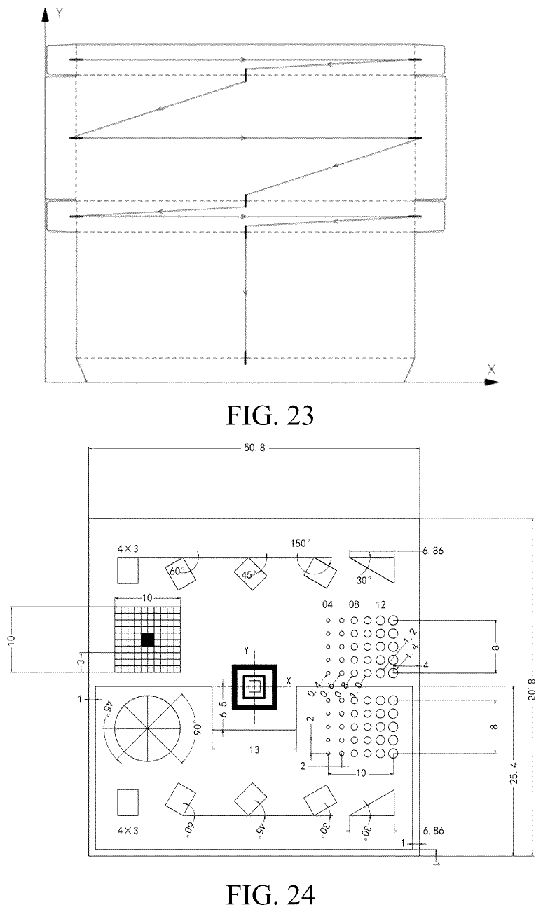

As shown in FIG. 23, in this embodiment, the moving path of the laser head sequentially measures indentations 1, 8, 4, . . . , and 7, and passes through the midpoints a, h, d, . . . , and g of indentations in sequence. During the entire detection process, the start point coordinates and end point coordinates of indentations and the midpoint coordinates of each indentation are shown in the following table:

Coordinate table of indentation midpoint of carton
trademark and start point of detection path

| Sampling | | | Start and end | | | |
|---|---|---|---|---|---|---|
| midpoint | X | Y | points of detection | | X | Y |
| a | 25.75 | 266.75 | 11 | (start point) | 20.75 | 266.75 |
| | | | 12 | (end point) | 30.75 | 266.75 |
| b | 306.25 | 266.75 | 21 | (start point) | 301.25 | 266.75 |
| | | | 22 | (end point) | 311.25 | 266.75 |
| c | 166 | 254 | 31 | (start point) | 166 | 259 |
| | | | 32 | (end point) | 166 | 249 |
| d | 25.75 | 202 | 41 | (start point) | 20.75 | 202 |
| | | | 42 | (end point) | 30.75 | 202 |
| e | 306.25 | 202 | 51 | (start point) | 301.25 | 202 |
| | | | 52 | (end point) | 311.25 | 202 |
| f | 166 | 150 | 61 | (start point) | 166 | 155 |
| | | | 62 | (end point) | 166 | 145 |
| g | 25.75 | 137 | 71 | (start point) | 20.75 | 137 |
| | | | 72 | (end point) | 30.75 | 137 |
| h | 306.25 | 137 | 81 | (start point) | 301.25 | 137 |
| | | | 82 | (end point) | 311.25 | 137 |
| i | 166 | 125 | 91 | (start point) | 166 | 129 |
| | | | 92 | (end point) | 166 | 119 |
| j | 166 | 20 | 101 | (start point) | 166 | 25 |
| | | | 102 | (end point) | 166 | 15 |

The determined internal control average value and internal control interval of the indentation depth of the carton trademark are shown in the following table:

Table of average indentation depth of carton trademark (unit: mm)

| | Indentation | Indentation | Indentation | Indentation | Indentation | Indentation | Indentation | Indentation | Indentation | Indentation |
|---|---|---|---|---|---|---|---|---|---|---|
| | number1 | number2 | number3 | number4 | number5 | number6 | number7 | number8 | number9 | number10 |
| Average | 0.13 | 0.16 | 0.15 | 0.15 | 0.17 | 0.13 | 0.18 | 0.14 | 0.17 | 0.14 |
| value | | | | | | | | | | |

Table of internal control range of indentation depth of carton trademark (unit: mm)

| | Indentation | Indentation | Indentation | Indentation | Indentation | Indentation | Indentation | Indentation | Indentation | Indentation |
|---|---|---|---|---|---|---|---|---|---|---|
| | number1 | number2 | number3 | number4 | number5 | number6 | number7 | number8 | number9 | number10 |
| Average | 0.13 | 0.16 | 0.15 | 0.15 | 0.17 | 0.18 | 0.13 | 0.14 | 0.17 | 0.14 |
| value | | | | | | | | | | |
| Upper | 0.16 | 0.19 | 0.17 | 0.21 | 0.23 | 0.23 | 0.22 | 0.17 | 0.19 | 0.17 |
| limit | | | | | | | | | | |
| Lower | 0.1 | 0.14 | 0.11 | 0.12 | 0.13 | 0.14 | 0.13 | 0.12 | 0.13 | 0.12 |
| limit | | | | | | | | | | |

Indentations 2 and 9 are in the gluing position. If they are not folded properly, the gluing is not strong. Indentations 4, 5, 6, and 7 are in the critical positions of the carton forming. If they are not folded properly, there are defects such as carton forming is poor and glass paper wrapping in the carton is not sufficiently tight. The indentations 1, 3, 8, and 10 are short, and their folding positions are relatively fixed and have little impact on the carton forming effect. Therefore, indentations 1, 3, 8, and 10 belong to the non-critical indentation group, and the remaining belongs to the critical indentation group.

All indentation depth data of the 20 samples of the carton trademarks measured in this embodiment is shown in the following table:

Sample measurement data table of carton trademark (unit: mm)

| | Indentation | Indentation | Indentation | Indentation | Indentation | Indentation | Indentation | Indentation | Indentation | Indentation |
|---|---|---|---|---|---|---|---|---|---|---|
| | serial | number | number | number | number | number | number | number | number | number |
| | number 1 | 2 | 3 | 4 | 5 | 6 | 7 | 8 | 9 | 10 |
| Average | 0.13 | 0.16 | 0.15 | 0.15 | 0.17 | 0.18 | 0.18 | 0.14 | 0.17 | 0.14 |
| value | | | | | | | | | | |
| Upper | 0.16 | 0.19 | 0.17 | 0.21 | 0.23 | 0.23 | 0.22 | 0.17 | 0.19 | 0.17 |
| limit | | | | | | | | | | |
| Lower | 0.10 | 0.14 | 0.11 | 0.12 | 0.13 | 0.14 | 0.13 | 0.12 | 0.13 | 0.12 |
| limit | | | | | | | | | | |
| 1 | 0.13 | 0.16 | 0.13 | 0.14 | 0.14 | 0.18 | 0.19 | 0.17 | 0.16 | 0.13 |
| 2 | 0.15 | 0.19 | 0.11 | 0.18 | 0.22 | 0.15 | 0.17 | 0.13 | 0.15 | 0.15 |
| 3 | 0.09 | 0.19 | 0.16 | 0.21 | 0.14 | 0.15 | 0.22 | 0.18 | 0.16 | 0.13 |
| 4 | 0.15 | 0.15 | 0.16 | 0.15 | 0.19 | 0.20 | 0.15 | 0.16 | 0.15 | 0.14 |
| 5 | 0.14 | 0.15 | 0.11 | 0.20 | 0.13 | 0.21 | 0.17 | 0.14 | 0.19 | 0.13 |
| 6 | 0.12 | 0.19 | 0.14 | 0.17 | 0.19 | 0.21 | 0.16 | 0.15 | 0.16 | 0.16 |
| 7 | 0.10 | 0.18 | 0.11 | 0.18 | 0.17 | 0.23 | 0.15 | 0.17 | 0.16 | 0.14 |
| 8 | 0.13 | 0.16 | 0.12 | 0.18 | 0.14 | 0.21 | 0.14 | 0.15 | 0.17 | 0.14 |
| 9 | 0.11 | 0.16 | 0.14 | 0.16 | 0.19 | 0.20 | 0.11 | 0.15 | 0.17 | 0.12 |
| 10 | 0.14 | 0.19 | 0.13 | 0.14 | 0.15 | 0.19 | 0.18 | 0.16 | 0.15 | 0.11 |
| 11 | 0.13 | 0.15 | 0.16 | 0.19 | 0.17 | 0.16 | 0.20 | 0.16 | 0.17 | 0.12 |
| 12 | 0.09 | 0.17 | 0.15 | 0.17 | 0.15 | 0.19 | 0.16 | 0.13 | 0.19 | 0.13 |
| 13 | 0.14 | 0.17 | 0.12 | 0.14 | 0.14 | 0.22 | 0.15 | 0.16 | 0.15 | 0.14 |
| 14 | 0.12 | 0.18 | 0.16 | 0.13 | 0.13 | 0.15 | 0.18 | 0.14 | 0.15 | 0.16 |
| 15 | 0.12 | 0.16 | 0.10 | 0.19 | 0.20 | 0.16 | 0.22 | 0.17 | 0.16 | 0.12 |
| 16 | 0.11 | 0.19 | 0.12 | 0.13 | 0.22 | 0.22 | 0.20 | 0.14 | 0.17 | 0.13 |
| 17 | 0.14 | 0.14 | 0.12 | 0.13 | 0.20 | 0.21 | 0.21 | 0.14 | 0.16 | 0.12 |
| 18 | 0.12 | 0.18 | 0.11 | 0.12 | 0.16 | 0.15 | 0.20 | 0.14 | 0.18 | 0.13 |
| 19 | 0.15 | 0.18 | 0.14 | 0.20 | 0.22 | 0.17 | 0.17 | 0.13 | 0.18 | 0.16 |
| 20 | 0.11 | 0.14 | 0.13 | 0.13 | 0.18 | 0.21 | 0.19 | 0.15 | 0.19 | 0.13 |

Through data comparison, it can be determined that among the 20 samples measured, all indentations of sample 1, sample 2, sample 4, sample 5, sample 6, sample 7, sample 8, sample 11, and sample 13, sample 14, sample 16, sample 17, sample 18, sample 19, and sample 20 are within the internal control range, and are trademarks with qualified indentation depths. In sample 3, the depths of indentation 1 and indentation 8 exceed the internal control range, and indentation 1 and indentation 8 belong to the non-critical indentation group. Besides, since the non-critical group includes no more than two indentations exceeding the standard, sample 3 is a carton trademark with a qualified indentation depth. In sample 9, the depth of indentation 7 exceeds the internal control standard, but since indentation 7 belongs to the critical indentation group, sample 9 is the carton trademark with an unqualified indentation depth. In sample 10, the depth of indentations 10 exceeds the internal control range, but indentation 10 is a non-critical indentation group. Therefore, sample 10 is a carton trademark with a qualified indentation depth. In sample 12, the depth of indentation 1 exceeds the internal control range, but indentation 1 belongs to the non-critical indentation group. Therefore, sample 12 is a carton trademark with a qualified indentation depth. In sample 15, the depth of indentation 3 exceeds the internal control range, but indentation 3 belongs to the non-critical indentation group. Therefore, sample 15 is a carton trademark with a qualified indentation depth.

19 of the 20 samples sampled from this batch of trademarks are qualified, with a pass rate of 95%. This batch of trademarks is qualified raw materials, expects to have good machine adaptability, and can enter the production process.

### Embodiment 5

In embodiment 1 to embodiment 4, the determination results of trademark die-cut size quality, trademark indentation width quality, trademark indentation depth quality, and trademark print quality all need to indicate qualified raw materials before materials can enter production process, otherwise materials are eliminated.

After a series of indicator control on trademarks, the overall defect rate drops by about 51.72% in a single day; and the defect rate caused by unqualified trademarks decreases by about 32.32%, which effectively reduces the defect rate of finished products, saves a series of supporting materials, and improves production efficiency.

It should be understood that the above-described specific embodiments of the present invention are only used to illustrate or explain the principles of the present invention, and do not constitute a limitation of the present invention. Therefore, any modifications, equivalent substitutions, improvements, or the like made without departing from the spirit and scope of the present invention should be included in the protection scope of the present invention. For example, for food packaging boxes, beverage packaging boxes, and gift packaging boxes, the method described in the present invention can be used to detect the size of the raw materials before the box is formed, so as to achieve the purpose of screening raw materials and reducing the defect rate of finished products. Furthermore, it is intended that the appended claims of the present invention cover all changes and modifications that fall within the scope and boundaries of the appended claims, or equivalents of such scopes and boundaries.

What is claimed is:

1. A defect rate reduction method for finished products based on trademark surface parameter detection and control, comprising following steps:
S1: performing pixel calibration: measuring a size of each pattern on a calibration piece with a CCD camera to obtain a corresponding pixel pattern, and establishing a correspondence between a display pixel and an actual size based on a ratio of the actual size to a size of the corresponding pixel pattern;
S2: performing database modeling: entering size parameters of various types of trademarks, printed patterns on the trademarks, and indentations on the trademarks into a database to generate basic images, collecting a corresponding standard trademark image in real time with the CCD camera for each basic image, and manually performing edge finding parameter optimization on the standard trademark image, to respectively find edge finding parameters that can be used to accurately extract the trademark edge, the indentation edge on the trademark, and printed pattern edge on the trademark on the standard trademark image, to complete the database modeling;
S3: extracting information: conducting sampling detection on a to-be-detected batch of trademarks, placing the to-be-detected sample trademark in an image collection area, setting a moving path of an edge finding frame of the CCD camera based on a database model, and collecting a to-be-detected trademark image with the CCD camera, to respectively extract a trademark edge, an indentation edge on the trademark, and a printed pattern edge on the trademark;
S4: performing quality determination: calculating a corresponding distance based on each extracted edge data information, and comparing the information with internal control to determine surface parameter quality of the sample trademark respectively, wherein the surface parameter quality comprises trademark die-cut size quality, trademark indentation width quality, and trademark print quality; and
S5: eliminating an unqualified batch: determining whether the batch of trademarks of the sample meets a production requirement based on a determination result of the surface parameter quality of the sample, and if any surface parameter quality fails, determining that the batch of trademarks of the sample is unqualified, and eliminating the unqualified batch of trademarks from raw material.

2. The defect rate reduction method for finished products based on trademark surface parameter detection and control according to claim 1, wherein the edge finding parameter in step S2 comprises precision, boundary strength, threshold, and burr size, and a worker optimizes the edge finding parameters in sequence.

3. The defect rate reduction method for finished products based on trademark surface parameter detection and control according to claim 2, wherein the optimization of the edge finding parameter in step S2 comprises following steps:
S2.1: performing precision selection, and performing Gaussian smoothing filtering on the collected CCD trademark image based on a 3×3 Gaussian filter window size, to eliminate noise interference;
$$G ( x , y ) = \frac{1}{2 π {σ}^{2}} {e}^{- ( {x}^{2} + {y}^{2} ) / ( 2 {σ}^{2} )} \qquad ( 1 )$$
wherein in formula (1), σ is a standard deviation of Gaussian distribution, G (x, y) represents a filtered image, x and y are coordinate positions of pixels; σ² is defined as image filtering precision, under a condition that a template is fixed, image noise suppression and image smoothing of different trademarks and print patterns are implemented by adjusting a σ² value, and the σ² value ranges from 1 to 20;
S2.2: performing grayscale conversion on the Gaussian filtered image to obtain a grayscale image of the trademark, wherein in conversion from RGB to YUV color spaces, a specific calculation method is:
$$Y = 0. 299 R + 0.587 G + 0.1 \; 14 B ; \qquad ( 2 )$$
$$U = 0.493 ( B - Y ) ; and \qquad ( 3 )$$
$$V = 0.877 ( R - Y ) ; \qquad ( 4 )$$
wherein in formulas (2), (3), and (4), R is a red component, G is a green component, B is a blue component, Y is brightness, U is chrominance, and V is chroma;
S2.3: performing edge detection on the grayscale image by using a Sobel operator, and extracting point coordinates of the trademark edge, the indentation edge on the trademark, and the printed pattern edge on the trademark; and
S2.4: performing fitting according to a least squares method based on coordinate points (x₁, y₁), (x₂, y₂), . . . , and (xₘ, yₘ) of the trademark edge, the indentation edge on the trademark, and the printed pattern edge on the trademark extracted by using the Sobel operator, wherein a regression equation of the least squares method is:
$$\hat{y} = \hat{a} + \hat{b} x ; \qquad ( 8 )$$
wherein the least squares method is used to minimize a sum of squares of deviations of yᵢ and a+bxᵢ, to obtain:
$$\hat{b} = \frac{{\sum }_{i = 1}^{m} ( {x}_{i} - \overline{x} ) ( {y}_{i} - \overline{y} )}{{\sum }_{i = 1}^{m} {( {x}_{i} - \overline{x} )}^{2}} , \hat{a} = \overline{y} - \hat{b} \overline{x} ; \qquad ( 9 )$$
$$\overline{y} = \frac{1}{m} ( {y}_{1} + {y}_{2} + … + {y}_{m} ) \qquad ( 10 )$$
$$\overline{x} = \frac{1}{m} ( {x}_{1} + {x}_{2} + … + {x}_{m} ) ; and$$
wherein:
through above steps, a straight line of each trademark edge, each indentation edge on the trademark, and each printed pattern edge on the trademark can be fitted, after first linear regression analysis, a pixel distance from each point to the fitted straight line is calculated, that is, the burr size, the burr size ranges from 1 pixel to 50 pixels, and the burr size is set to remove discrete points with large distances.

4. The defect rate reduction method for finished products based on trademark surface parameter detection and control according to claim 3, wherein step S2.3 comprises following steps:
S2.3.1: the Sobel operator comprises two 3×3 matrices that are horizontal and vertical respectively, and performing plane convolution on the matrices and the grayscale image, to respectively obtain approximate values of horizontal and vertical grayscale gradients:
$${G}_{x} = [ \begin{matrix}- 1 & 0 & + 1 \\ - 2 & 0 & + 2 \\ - 1 & 0 & + 1\end{matrix} ] * A ; and \qquad ( 5 )$$
$${G}_{y} = [ \begin{matrix}- 1 & - 2 & - 1 \\ 0 & 0 & 0 \\ + 1 & + 2 & + 1\end{matrix} ] * A ; \qquad ( 6 )$$
wherein in formulas (5) and (6), Gₓ and G_{y} represent the approximate values of the horizontal and vertical gradients respectively, and A represents an original grayscale image;
S2.3.2: calculating a grayscale gradient based on horizontal and vertical grayscale gradients of each pixel in the image:
$$G = \sqrt{{G}_{x}^{2} + {G}_{y}^{2}} ; and \qquad ( 7 )$$
S2.3.3: selecting an appropriate boundary strength B and gradient threshold T, and comparing a grayscale value and a grayscale gradient of each pixel in the edge finding frame area with B and T respectively based on a row-by-row or column-by-column search method, wherein only points that satisfy both grayscale value A (x, y)≥B and gradient G (x, y)≥T are edge points, and other points are non-edge points.

5. The defect rate reduction method for finished products based on trademark surface parameter detection and control according to claim 4, wherein the threshold T ranges from 0.1 to 0.95;
the boundary strength B for extracting the trademark edge ranges from 1 to 200;
the boundary strength B for extracting the indentation edge on the trademark ranges from 32 to 59; and
the boundary strength B for extracting the printed pattern edge on the trademark ranges from 1 to 76.

6. The defect rate reduction method for finished products based on trademark surface parameter detection and control according to claim 5, wherein in steps S2 and S3, a combined LED light source is used when collecting images with the CCD camera, the combined LED light source comprises a top light source arranged around the CCD camera and a bottom light source arranged below the image collection area;
the top light source comprises a top upper light source, a top lower light source, a top left light source, and a top right light source;
the top light source is used to extract the printed pattern edge on the trademark and a light source intensity coefficient of the top light source is between 31 and 77;
the top light source is used to extract the indentation edge and a light source intensity coefficient of the top light source is between 31 and 49;
the bottom light source is used to extract the trademark edge and a light source intensity coefficient of the bottom light source is between 25 and 60;
when measuring an upper edge of a transverse indentation, only the top upper light source is turned on;
when measuring a lower edge of the transverse indentation, only the top lower light source is turned on;
when measuring a left edge of a longitudinal indentation, only the top left light source is turned on; and
when measuring a right edge of the longitudinal indentation, only the top right light source is turned on.

7. The defect rate reduction method for finished products based on trademark surface parameter detection and control according to claim 1, wherein the trademark comprises a pack trademark and a carton trademark, a determination method of trademark print quality of the pack trademark in step S4 is:
transversely placing the pack trademark,
dividing the printed pattern on the pack trademark into three areas of left, middle, and right areas according to pattern edges, grayscale differences, and positions after folding into a box,
respectively calculating distances from the printed pattern in each area to upper and lower side edges of the pack trademark,
determining print quality defect based on the calculated distances;
wherein the print quality defect determination comprises a deviation degree and a skewness degree;
calculating absolute values of differences between distances from upper and lower side edges of the printed pattern in each area to the upper and lower side edges of the pack trademark to determine deviation degrees of the printed patterns in the three areas; and
calculating an absolute value of a difference between a distance from the printed pattern edge in the left area on a same side to the edge of the pack trademark and a distance from the printed pattern edge in the right area to the edge of the pack trademark to determine an overall skewness degree of the printed pattern; and
a determining method of trademark print quality of the carton trademark in step S4 is:
transversely placing a top of the carton trademark to the left,
dividing into two areas of an upper detection area and a lower detection area according to pattern edges, grayscale differences, and positions after folding into the box, and
calculating absolute values of differences between distances from the printed pattern edges in the two areas to the edge of the carton trademark on the same side to determine the overall skewness degree of the printed pattern.

8. The defect rate reduction method for finished products based on trademark surface parameter detection and control according to claim 1, wherein the trademark comprises a pack trademark and a carton trademark;
in determining of the trademark indentation width quality in step S4, all indentations are divided into a critical indentation group and a non-critical indentation group, indentations at gluing and folding positions and indentations at critical folding positions for cigarette pack forming belong to the critical indentation group, remaining indentations belong to the non-critical indentation group,
if the critical indentation group comprises one indentation with a width exceeding an internal control range, it is determined that the trademark indentation width quality fails, and
if the non-critical indentation group comprises more than two indentations with widths exceeding the internal control range, it is determined that the trademark indentation width quality fails.

9. The defect rate reduction method for finished products based on trademark surface parameter detection and control according to claim 1, wherein the trademark comprises a pack trademark and a carton trademark;
in determining of the trademark die-cut size quality in step S4, sizes of various parts that affect an effect of trademark pack forming are first marked as different detection sequences, all the detection sequences are divided into a critical detection sequence group and a non-critical detection sequence group, detection sequences at gluing and folding positions belong to the critical detection sequence group, remaining detection sequences belong to the non-critical detection sequence group,
if the critical detection sequence group comprises one detection sequence with a size exceeding an internal control range, it is determined that the trademark die-cut size quality fails, and
if the non-critical detection sequence group comprises more than two detection sequences with sizes exceeding the internal control range, it is determined that the trademark die-cut size quality fails.

10. The defect rate reduction method for finished products based on trademark surface parameter detection and control according to claim 1, wherein between step S4 and step S5, determining of trademark indentation depth quality is further comprised;
the trademark comprises a pack trademark and a carton trademark; and the determining of the trademark indentation depth quality comprises following steps:
S4.1: selecting points for distance measurement: replacing the CCD camera on detection equipment with a laser detection head, measuring to-be-measured indentation depths of samples one by one through laser ranging, wherein a laser path is perpendicular to the trademark surface during measurement, and performing laser ranging on several points between two side edges of each to-be-measured indentation along a specific distance, to measure a distance between each point and the laser head;
S4.2: performing indentation depth calculation: subtracting a minimum value of measured distances from a maximum value to obtain an indentation depth; and
S4.3: performing indentation depth quality determination: grouping all indentations according to a process of folding the trademark into a box and a position of each indentation in the trademark, wherein different quality determination standards are used for different groups of indentations, comparing all indentations with an indentation internal control range, and determining, according to different quality determination standards, whether the indentation depth quality is fine.

11. The defect rate reduction method for finished products based on trademark surface parameter detection and control according to claim 10, wherein when selecting points for distance measurement in step S4.1, points start to be selected from a trademark surface that is on one side of the indentation and that is 5 mm away from the indentation, a line connecting the selected measurement points passes through an inside of the indentation, points are selected for distance measurement until a position that is on an other side of the indentation and that is 5 mm away from an edge of the other side of the indentation,
thirty points evenly spaced between a start point and an end point are collected,
a line connecting the selected measurement points passes through a midpoint of each indentation, a line connecting points selected when measuring each indentation is perpendicular to the indentation,
each indentation is measured in sequence from left to right and from top to bottom during distance measurement,
after each indentation is measured, the laser head moves in a straight line from a collection end point of the measured indentation to a collection start point of a next to-be-measured indentation, and
when measuring a distance of a first indentation, a moving path of the laser head points to a second indentation.

12. The defect rate reduction method for finished products based on trademark surface parameter detection and control according to claim 11, wherein in step S4.3, all indentations are divided into a critical indentation group and a non-critical indentation group, indentations at gluing and folding positions and indentations at critical folding positions for cigarette pack forming belong to the critical indentation group, remaining indentations belong to the non-critical indentation group,
if the critical indentation group comprises one indentation with a depth exceeding an internal control range, it is determined that the trademark indentation depth quality fails, and
if the non-critical indentation group comprises more than two indentations with depths exceeding the internal control range, it is determined that the trademark indentation depth quality fails.
